(19) United States
(12) Patent Application Publication
(10) Pub. No.: US 2012/0039078 A1
(43) Pub. Date: Feb. 16, 2012

(54) LIGHTING DEVICE AND DISPLAYING DEVICE

(75) Inventors: Takeshi Masuda, Osaka (JP); Atsuyuki Tanaka, Osaka (JP); Yuhsaku Ajichi, Osaka (JP)

(73) Assignee: SHARP KABUSHIKI KAISHA, Osaka (JP)

(21) Appl. No.: 13/266,233

(22) PCT Filed: Feb. 5, 2010
(86) PCT No.: PCT/JP2010/051674

§ 371 Date: Oct. 25, 2011

(30) Foreign Application Priority Data
Apr. 28, 2009 (JP) 2009-109073

(51) Int. Cl. F21V 5/02; F21V 5/00

(52) U.S. Cl. 362/311.03; 362/311.01; 362/311.06

(57) ABSTRACT

A triangle prism (PR1) that refracts light coming from a first light-reception face (RS1) is formed on a first outgoing face (IS1) of a first prism sheet (PS1). Furthermore, one of the side surfaces (SS1a, SS2a) of that triangle prism (PR1) will refract light coming from the first light-reception face (RS1), and the other side surface will refract light coming from that side surface.

### TECHNICAL FIELD

The present invention relates to a lighting device such as a backlight unit, and to a display device such as a liquid crystal display device.

### BACKGROUND ART

When a display panel such as a liquid crystal display panel is a non light-emitting type, a backlight unit that supplies light (backlight light) to the liquid crystal display panel is mounted in a liquid crystal display device. And, the backlight unit is mounted with a light source in various ways. A direct lighting system is one example. In this direct lighting system, a plurality of LEDs (Light Emitting Diodes) are arranged in a matrix, and a group of the LEDs in a matrix is aligned in parallel with a panel surface of the liquid crystal display panel.

In such a backlight unit in which LEDs are mounted by a direct lighting system (a direct lighting backlight unit), a diffusion sheet is disposed over a surface where the LEDs are mounted. When a surface of the diffusion sheet is observed, an image such as the one shown in FIG. 25 is viewed.

Here, as shown in this image, an unevenness in light amount in which an area directly above an LED is brighter than the other areas occurs in a direct lighting backlight unit. One measure to resolve such unevenness in light amount is to make the distance between each LED narrower. However, even though this measure suppresses unevenness in light amount, the number of LEDs is increased, and thereby increasing the cost of the backlight unit.

On the other hand, when attempting to suppress the unevenness in light amount while minimizing the number of LEDs in order to reduce the cost, it is necessary to increase the distance between the LED-mounted surface and the diffusion sheet (in other words, the thickness of the backlight unit needs to be increased). This is because if the distance between the LED-mounted surface and the diffusion sheet is too small, light is not likely to reach an upper side of an area between each LED, and the unevenness in light amount is not resolved.

Therefore, in order to resolve the unevenness in light amount (in other words, in order to secure luminance uniformity of light from a backlight unit), a backlight unit has to either increase in cost or increase in thickness. Here, a backlight unit of Patent Document 1 is one example of a measure to secure luminance uniformity while maintaining the cost relatively low and suppressing an increase in thickness, for example. In this backlight unit, as shown in FIG. 26, a prism sheet (transmission sheet) ps is disposed over a surface where LEDs 112 are mounted.

This way, as shown in FIG. 27, light (see arrow dashed lines) from the LED 112 travels in various directions from an outgoing face “is” of the prism sheet ps. Accordingly, an unevenness in light amount in which an area directly above the LED 112 is brighter than the other areas is not likely to occur.

### RELATED ART DOCUMENTS

### Patent Documents

Patent Document 1: Japanese Patent Application Laid-Open Publication 2002-049324

### SUMMARY OF THE INVENTION

### Problems to be Solved by the Invention

However, as shown in FIGS. 26 and 27, a prism pr, which is formed in a light-reception face rs of the prism sheet ps, is a triangle prism pr that tapers off toward the LED 112. Therefore, incident light to this triangle prism pr is only refracted by one of side surfaces (refractive surfaces) ss of the triangle prism pr. Accordingly, it cannot be said that incident light to the prism sheet pr travels sufficiently away from the LED 112 (that is to say, because the angle of refraction by only one refraction is limited, and light is not sufficiently separated from the LED 112).

The present invention was devised in order to resolve the above-mentioned problems. An object of the present invention is to provide a lighting device such as a backlight unit that emits backlight light with suppressed unevenness in light amount by increasing the amount of light that travels away from the light source, and also to provide a display device mounted with such a lighting device.

### Means for Solving the Problems

The lighting device includes a light source, and a transmission sheet including a light-reception face for receiving light from the light source and an outgoing face for emitting light that has passed through the light-reception face. In this lighting device, the outgoing face includes a light refractive element at least having a first refractive face, which refracts light coming from the light-reception face, and a second refractive face, which refracts light coming from the first refractive face as side surfaces.

When light is transmitted between the first refractive face and the second refractive face this way, a light refractive element including these first refractive face and second refractive face as side surfaces has a shape that tapers off toward the side separating from the light-reception face. Accordingly, a large part of light coming from the light-reception face is refracted twice by the two refractive faces of the light refractive element formed in the outgoing face, and therefore, the amount of light traveling away from the light source is likely to increase. As a result, the lighting device no longer emits light with partial bright regions reflecting a shape of the light source, and the unevenness in light amount can be suppressed.

The lighting device that satisfies a formula below (F1) is especially preferable.

$$\begin{matrix}[ Formula F 1 ] & \\ ( 90 ° - \frac{θ}{2} ) + {sin}^{- 1} [ n \cdot sin \{ 180 ° - 3 \cdot ( 90 ° - \frac{θ}{2} ) \} ] > {sin}^{- 1} [ n \cdot sin \{ ( 90 ° - \frac{θ}{2} ) - {sin}^{- 1} ( \frac{sin ( 90 ° - \frac{θ}{2} )}{n} ) \} ] & ( F1 )\end{matrix}$$

### Here,

θ: an angle formed by the first refractive face and the second refractive face
n: a refractive index of the transmission sheet.

Moreover, when the refractive index of the transmission sheet is 1.5, it is preferable that an angle θ formed by the first refractive face and the second refractive face satisfies a formula below (A1).

50°≦θ<88° formula (A1)

The lighting device that satisfies a formula below (F2) is preferable.

$$\begin{matrix}[ Formula F 2 ] & \\ 90 ° > ( 90 ° - \frac{θ}{2} ) + {sin}^{- 1} [ n \cdot sin \{ 180 ° - 3 \cdot ( 90 ° - \frac{θ}{2} ) \} ] > {sin}^{- 1} [ n \cdot sin \{ ( 90 ° - \frac{θ}{2} ) - {sin}^{- 1} ( \frac{sin ( 90 ° - \frac{θ}{2} )}{n} ) \} ] & ( F2 )\end{matrix}$$

It is especially preferable that a formula below (A2) be satisfied.

50°≦θ<76° formula (A2)

Further, it is preferable that a formula below (A3) be satisfied.)

65(°)≦θ76(°) formula (A3)

It is preferable that a formula below (B1) be satisfied when a first diffusion sheet for receiving light that has passed through the transmission sheet is included.

0.35<D(L−R)/D(L−DS)<1 formula (B1)

Here,
D (L-R): the shortest distance from the light source to a connecting line of the first refractive face and the second refractive face of the light refractive element in the transmission sheet
D(L-DS): the shortest distance from the light source to the first diffusion sheet.

Moreover, it is especially preferable that a formula below (B2) be satisfied.

0.5≦D(L−R)/D(L−DS)≦0.75 formula (B2)

Further, it is preferable that a formula below (B3) be satisfied.

0.5≦D(L−R)/D(L−DS)≦0.625 formula (B3)

It is preferable that a connecting line of the first refractive face and the second refractive face be perpendicular to a direction in which the light source is aligned.

This way, light coming from the first refractive face and light coming from the second refractive face is likely to reach an area between respective light sources. Therefore, a difference in luminance is not likely to occur between a light source and an area between light sources.

For example, when the light source is point light sources that are arranged two dimensionally, and if one direction and the other direction that are perpendicular to each other on a two dimensional surface are called a first direction and a second direction, it is preferable that the connecting line become perpendicular to one of the first direction and the second direction, which is a direction in which the point light sources are aligned.

This way, in a direction perpendicular to the connecting line, a difference in luminance is not likely to occur between the light sources and an area between the light sources.

Here, it is preferable that there be a plurality of the transmission sheets overlapping with each other, and the transmission sheet on a side close to the light source be called a first transmission sheet, and the transmission sheet on a side far from the light source be called a second transmission sheet, and that a connecting line of the first transmission sheet become perpendicular to one of the first direction and the second direction, and a connecting line of the second transmission sheet become perpendicular to the other one of the first direction and the second direction.

This way, a difference in luminance can be suppressed between the light sources and areas between the light sources in both of one direction and the other direction that are perpendicular to each other on the two dimensional surface.

Further, when there is a difference between a length of an arrangement interval of the point light sources along the first direction and a length of an arrangement interval of the point light sources along the second direction, it is preferable that the direction of a longer arrangement interval become perpendicular to the connecting line of the second transmission sheet.

When the distance of an arrangement interval of point light sources is long, light is usually not likely to reach an area between respective light sources. However, light refractive elements in the second transmission sheet, which is located on a side close to a viewer of light of the lighting device, can spread light to an area between respective light sources, and therefore, light emitted from the lighting device does not include unevenness in light amount.

The light source of the lighting device is not limited to point light sources, and it may be linear light sources that are aligned next to each other.

One example of the light refractive element is a prism.

It is preferable that the prism be a triangle prism having an isosceles triangle cross-section in which side surfaces are the first refractive face and the second refractive face having an equal length.

When the light refractive element is a prism, the prism may be a point-like prism including another refractive face as a side surface in addition to the first refractive face and the second refractive face.

Moreover, a surface of the prism may be a curved surface that is convex toward a light outgoing side of the transmission sheet. This is because light exiting from a curved surface is likely to travel in various directions, and unevenness in light amount can be further suppressed.

There are various ways to make light exiting from the transmission sheet travel in various directions. For example, recesses and projections for scattering light may be formed in at least a part of a surface of the transmission sheet. Or the transmission sheet may include a light diffusion material.

Further, if a second diffusion sheet for receiving light from the transmission sheet is included, light traveling in various directions from the transmission sheet is further diffused, and therefore, light from the lighting device does not include unevenness in light amount.

The light refractive element is not limited to a prism, and it may be a hologram, for example.

A display device including the lighting device described above and a display panel for receiving light from the lighting device is also the present invention.

### Effects of the Invention

According to the present invention, incident light to the transmission sheet is released after being refracted multiple times by the light refractive element including two refractive faces formed in the outgoing face. Therefore, the amount of light that travels to be separated from the light source is likely to increase. As a result, a lighting device including such a transmission sheet no longer emits light with partial bright regions reflecting a shape of the light source, and unevenness in light amount can be suppressed.

### BRIEF DESCRIPTION OF THE DRAWINGS

FIG. 1 is an exploded perspective view of a liquid crystal display device of Example 1.

FIG. 2 is a cross-sectional arrow view along the line A1-A1′ of FIG. 1.

FIG. 3 is an exploded perspective view of a liquid crystal display device of a comparative example.

FIG. 4 is a cross-sectional arrow view along the line a1-a1′ of FIG. 3.

FIG. 5 is a characteristics diagram showing a comparison between a vertex angle θ of a prism in a prism sheet and an outgoing angle 8 with respect to a prism sheet.

FIG. 6A is a light path view showing a path of light that transmits through a prism sheet.

FIG. 6B is a light path view showing a path of light that transmits through a prism sheet.

FIG. 6C is a light path view showing a path of light that transmits through a prism sheet.

FIG. 6D is a light path view showing a path of light that transmits through a prism sheet.

FIG. 7 is a light path view showing an example of light that transmits through a prism.

FIG. 8 is a light path view showing an example of light that transmits through a prism.

FIG. 9A is a light path view showing light that transmits through a prism sheet.

FIG. 9B is a light path view showing light that transmits through a prism sheet.

FIG. 9C is a light path view showing light that transmits through a prism sheet.

FIG. 9D is a light path view showing light that transmits through a prism sheet.

FIG. 10 is a light path view showing how light traveling in various directions from an LED transmits through the prism sheet.

FIG. 11 is a chart showing images of planar light that is viewed in Example 1 and the comparative example.

FIG. 12 is a light path view showing an example of light that transmits through a prism.

FIG. 13 is a light path view showing an example of light that transmits through a prism.

FIG. 14 is an exploded perspective view of a liquid crystal display device of Example 2.

FIG. 15 is a cross-sectional arrow view along the line A2-A2′ of FIG. 14.

FIG. 16 is an exploded perspective view of a liquid crystal display device of Example 3.

FIG. 17 is a cross-sectional arrow view along the line A3-A3′ of FIG. 16.

FIG. 18 is an explanatory view showing both an image of planar light viewed in Example 2 and a characteristics graph of positions and luminance in the planar light.

FIG. 19 is an explanatory view showing both an image of planar light viewed in Example 3 and a characteristics graph of positions and luminance in the planar light.

FIG. 20 is an exploded perspective view of a liquid crystal display device of Example 4.

FIG. 21 is a cross-sectional arrow view along the line A4-A4′ of FIG. 20.

FIG. 22 is a cross-sectional view of a prism sheet in which prisms with curved side surfaces are arranged.

FIG. 23A is an example of an image of planar light that has passed through a prism sheet in which prisms with curved side surfaces are arranged.

FIG. 23B is an example of an image of planar light that has passed through a prism sheet in which prisms with curved side surfaces are arranged.

FIG. 23C is an example of an image of planar light that has passed through a prism sheet in which prisms with curved side surfaces are arranged.

FIG. 23D is an image of planar light that has passed through a prism sheet in which prisms with flat side surfaces are arranged.

FIG. 24 is an explanatory view showing the center of curvature of the curved surface, which is a side surface of a prism.

FIG. 25 is an image showing planar light that is emitted from a conventional backlight unit.

FIG. 26 is a cross-sectional view of a liquid crystal display device including a conventional backlight unit.

FIG. 27 is a light path view of light that transmits through a prism sheet of the backlight unit shown in FIG. 26.

### DETAILED DESCRIPTION OF EMBODIMENTS

### Embodiment 1

Embodiment 1 is described below based on the figures. Here, hatchings, member characters, and the like may be omitted for convenience, but in those cases, other figures should be referred to. A black dot along with arrows shown in the figures indicates directions perpendicular to the plane of paper. Further, numeric examples included here are only examples, and the present invention is not limited to those numbers. A unit used for angles included here is (°), and it may be omitted in some cases.

Further, a description is made below on a liquid crystal display device as an example of a display device (Example 1), but the present invention is not limited to this, and other display devices may also be used (of course, lighting devices other than a backlight unit, which will be described later, may be encompassed as well).

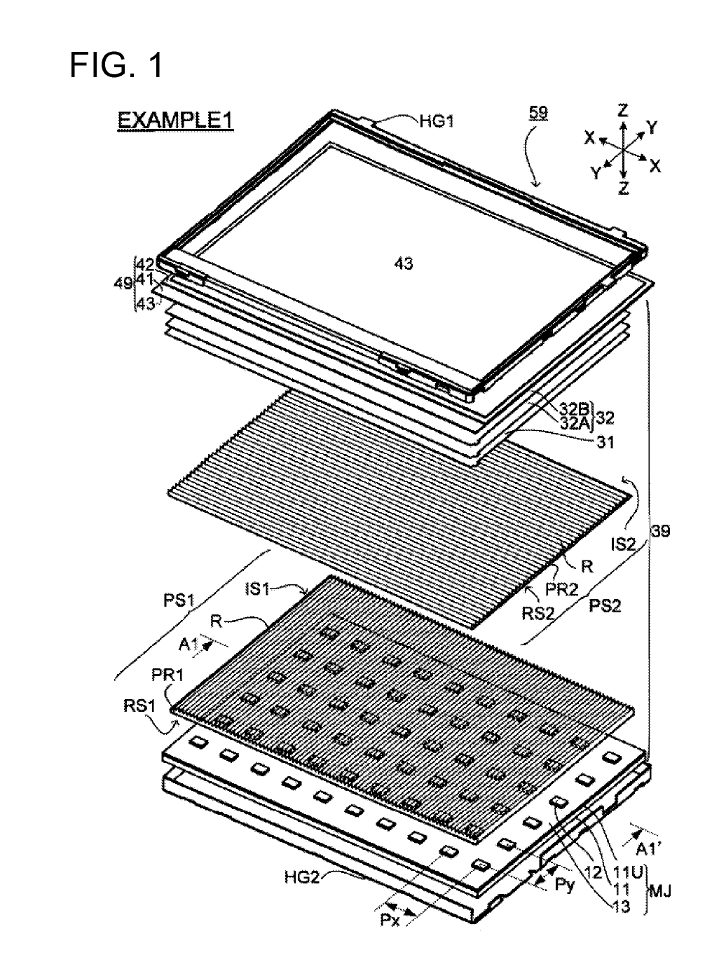

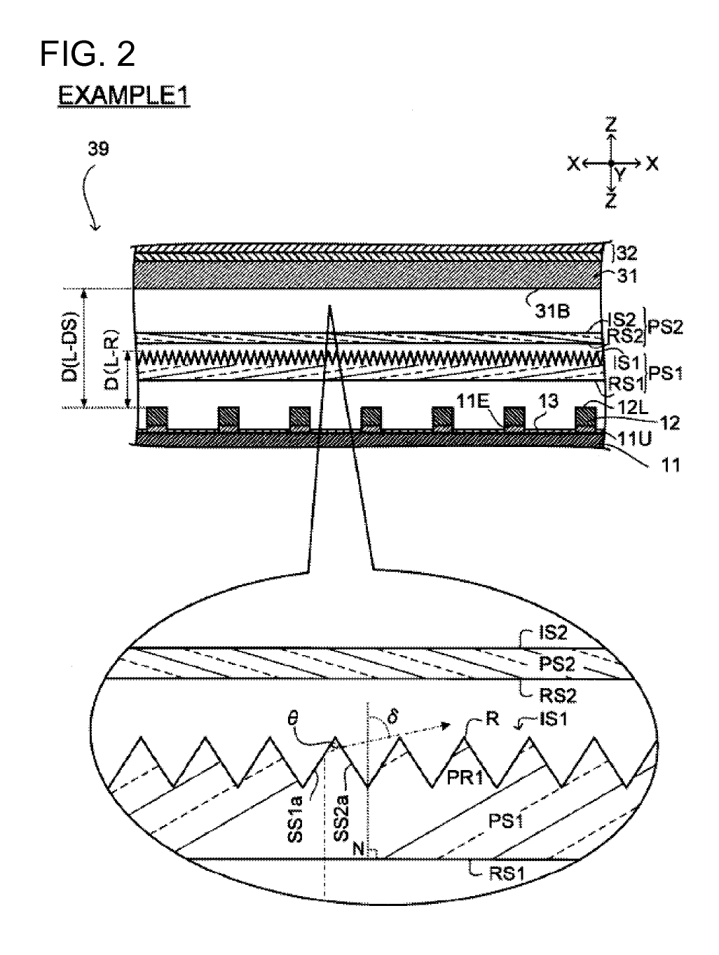

FIG. 1 is an exploded cross-sectional view of a liquid crystal display device 59, and FIG. 2 is a cross-sectional arrow view along the line A1-A1′ of FIG. 1. As shown in FIG. 1, the liquid crystal display device 59 includes a liquid crystal display panel (display panel) 49, a backlight unit (lighting device) 39, and housings HG (front housing HG1 and rear housing HG2) that sandwiches the liquid crystal display panel and the backlight unit.

In the liquid crystal display panel 49, an active matrix substrate 41 that includes switching elements such as TFTs (Thin Film Transistors) and an opposite substrate 42 facing this active matrix substrate 41 are attached together by a sealing material (not shown in the figure). Liquid crystal (not shown in the figure) is injected to a gap between these two substrates 41 and 42 (moreover, polarizing films 43 and 43 are attached so as to sandwich the active matrix substrate 41 and the opposite substrate 42). Such a liquid crystal display panel 49 displays an image by using a change in transmittance caused by inclination of liquid crystal molecules.

The backlight unit 39 overlaps with the liquid crystal display panel 49, and emits light onto this non light-emitting liquid crystal display panel 49. That is, the liquid crystal display panel 49 improves its display function by receiving light (backlight light) from the backlight unit 39. Therefore, if the entire surface of the liquid crystal display panel 49 can be irradiated evenly with light from the backlight unit 39, the display quality of the liquid crystal display panel 49 is improved.

This backlight unit 39 includes, as shown in FIG. 1, an LED module MJ, prism sheets PS (a first prism sheet PS1 and a second prism sheet PS2), a diffusion sheet 31, and optical sheets 32 (32A and 32B).

The LED module MJ includes a mounting substrate 11, LEDs (Light Emitting Diodes) 12, and a reflective sheet 13. Over the mounting substrate 11, electrodes 11E are arranged in a planar manner (in a matrix, for example), and the LEDs (light sources, light emitting elements) 12 are mounted on those electrodes 11E. The mounting substrate 11 supplies current from a power source, which is not shown in the figure, to the LEDs 12 through the electrodes 11E.

The LEDs 12 are point light sources that emit light by receiving current supplies, and are arranged corresponding to the electrodes 11E over a mounting surface 11U of the mounting substrate 11 (here, the direction of a light emitting surface 12L of the LEDs 12 is same as the direction of the mounting surface 11U on which the electrodes 11E are arranged). As a result, the LEDs 12 are arranged over the mounting surface 11U of the mounting substrate 11 in a planar manner (two dimensional arrangement), and generate planar light. 100481 One example of the arrangement of the LEDs 12 is a planar arrangement in a rectangular shape as well as in a matrix, as shown in FIG. 1. Here, for convenience, a long direction of the rectangle is called a X direction, a short direction is called a Y direction, and a direction crossing (a direction perpendicular to, for example) the X direction and the Y direction is called a Z direction. A surface formed by the LEDs 12 that are arranged in a matrix is called an LED-mounted surface XY (the LED-mounted surface XY, which is a two dimensional surface, is in the same direction as the direction of a surface formed by the X direction and the Y direction, and therefore, the character XY is used). An arrangement interval Px of the LEDs 12 in the X direction is same as an arrangement interval Py of the LEDs 12 in the Y direction.

Over the mounting surface 11U, the reflective sheet (reflector) 13 is attached to a region other than the electrodes 11 E, and the reflective sheet 13 reflects a part of light from the LEDs 12. In other words, the reflective sheet 13 makes light coming toward the mounting surface 11U travel away from the mounting surface 11U (one example of the reflective sheet 13 is the lumirror E6SV manufactured by TORAY INDUSTRIES, INC., for example).

There are two prism sheets PS, and they are laminated. A prism sheet PS located below is called a first prism sheet PS1, and a prism sheet PS located above is called a second prism sheet PS2.

The first prism sheet PS1 includes a light-reception face RS (a first light-reception face RS1), which receives light from the LEDs 12 and light from the reflective sheet 13, and an outgoing face IS (a first outgoing face IS1), which releases light that has passed through this first light-reception face RS1. Further, in the first prism sheet PS1, triangle prisms PR, which have a linear shape extending in the Y direction, are arranged in the first outgoing face IS1 along the X direction (the triangle prism PR of the first prism sheet PS1 is called a triangle prism PR1). This first prism sheet PS1 refracts light coming from the first light-reception face RS1 by two side surfaces SS (a first refraction face and a second refraction face) of a surface of the triangle prism PR1, and releases the light to outside.

The second prism sheet PS2 overlaps with the first outgoing face IS1 of the first prism sheet PS1. Therefore, the second prism sheet PS2 includes a light-reception face RS (a second light-reception face RS2) that receives light coming from the first outgoing face IS1 of the first prism sheet PS1, and an outgoing face IS (a second outgoing face IS2) that releases light that has passed through this second light-reception face RS2.

Specifically, in the second prism sheet PS2, triangle prisms PR, which have a linear shape extending in the X direction, are arranged in the second outgoing face IS2 along the Y direction (here, the triangle prism PR of the second prism sheet PS2 is called a triangle prism PR2). In a similar manner as the first prism sheet PS1, this second prism sheet PS2 refracts light coming from the first light-reception face RS1 by two side surfaces SS (a first refraction face and a second refraction face) of a surface of the triangle prism PR2, and releases the light to outside.

Furthermore, the two prism sheets PS1 and PS2 overlap with each other such that the first outgoing face IS1 of the first prism sheet PS I and the second light-reception face RS2 of the second prism sheet PS2 face each other, and that ridge lines R of the triangle prisms PR1 and PR2 in the two prism sheets PS1 and PS2 are perpendicular to each other (here, the ridge lines R of the triangle prism PR1 of the first prism sheet PS1 are in a direction same as the Y direction, and the ridge lines R of the triangle prism PR2 of the second prism sheet PS2 are in a direction same as the X direction). Here, the ridge line R of the triangle prism PR is a connecting line that is formed by the connection between one side surface SS1 and other side surface SS2 of the side surfaces SS of the triangle prism PR.

The diffusion sheet 31 (a first diffusion sheet) overlaps with the second outgoing face IS2 of the second prism sheet PS2. The diffusion sheet 31 receives and then diffuses light that has passed through the first prism sheet PS1 and the second prism sheet PS2, and spread the light to the entire region of the liquid crystal display panel 49 (one example of the diffusion sheet 31 is PC-9391, which is polycarbonate manufactured by TEIJIN CHEMICALS LTD., for example).

The optical sheets 32 (32A and 32B) are luminance increasing sheets, for example. The optical sheets 32 for increasing the luminance focus light passing through the sheets by taking advantage of multiple reflection and refractive index of light to increase the luminance (an example of the optical sheets 32 for increasing luminance is BEF and DBEF manufactured by Sumitomo 3M Limited, for example).

Moreover, the optical sheets 32 are not limited to luminance increasing sheets, and they may be sheets for diffusing light such as the diffusion sheet 31 (an example of the optical sheets 32 for diffusing light is BS-912 manufactured by KEIWA INC., for example).

In the backlight unit 39 described above, light from the LEDs 12 travels through the first prism sheet PS1, the second prism sheet PS2, the diffusion sheet 31, and the optical sheets 32 (32A and 32B), and then the light is emitted as backlight light with increased light-emitting luminance. This backlight light then reaches the liquid crystal display panel 49, and the image quality of the liquid crystal display panel 49 is improved by the backlight light.

Here, in the backlight unit 39 described above, the LEDs 12 are arranged in a matrix (along the X direction as well as the Y direction) in the LED module MJ. Therefore, if light emitted from each LED 12 does not spread properly along the X direction and the Y direction, when the backlight light (planar light) is observed in a plan view, the area of the LEDs 12 becomes brighter than the other areas (the LEDs 12 are reflected on the planar light). That is to say, planar light having unevenness in light amount is generated.

As a measure for such unevenness in light amount, as shown in FIG. 2, it is preferable that light be emitted having a relatively large outgoing angle δ with respect to a normal direction N of a sheet surface direction of the first prism sheet PS1 (a surface direction same as the direction of the first light-reception face RS1), for example. And, the backlight unit 39 described above is designed such that light having a relatively large outgoing angle δ is emitted from the prism sheet PS. Therefore, unevenness in light amount can be suppressed in the backlight unit 39.

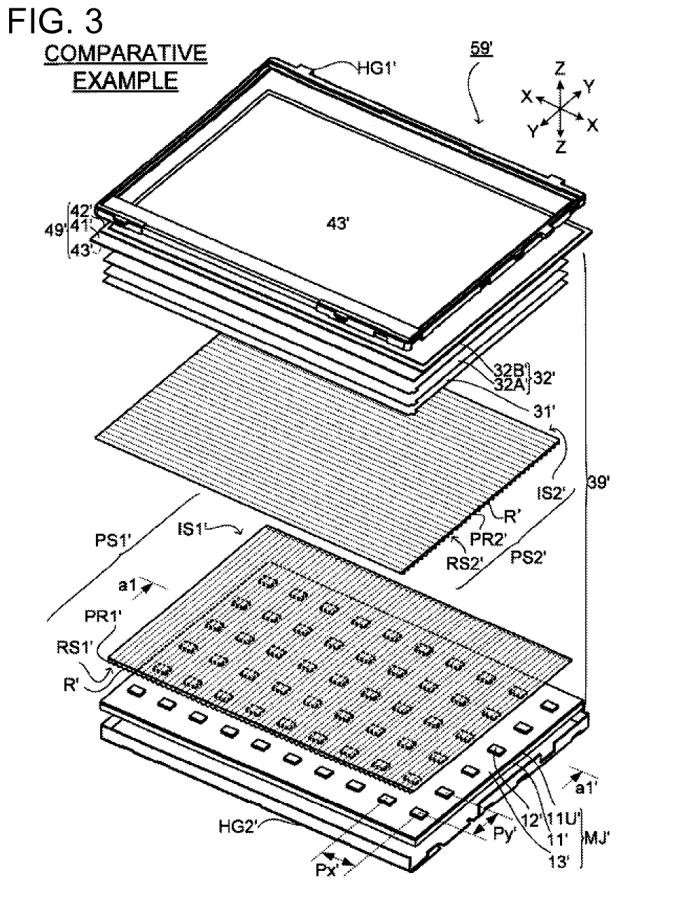

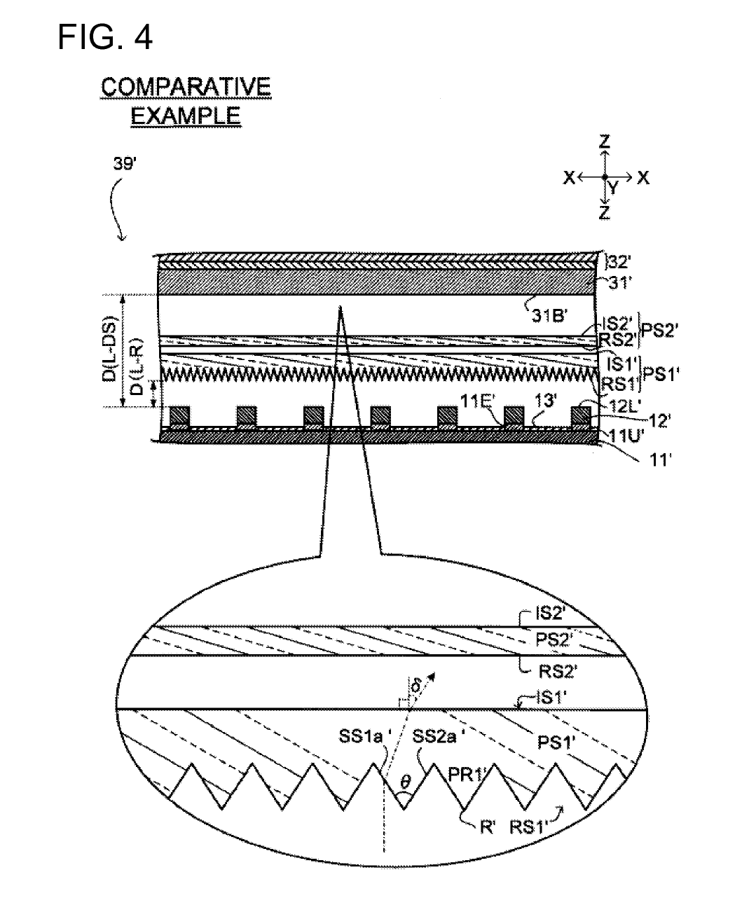

Here, the backlight unit 39 in which such unevenness in light amount is suppressed (for convenience, it is referred to as the backlight unit 39 of Example 1; see FIGS. 1 and 2) is described by using a backlight unit 39′ that emits planar light with unevenness in light amount as a comparative example (the comparative example is shown in the exploded perspective view of FIG. 3, and in FIG. 4, which is a cross-sectional arrow view along the line a1-a1′ of FIG. 3).

Further, the first prism sheet PS1 is mainly described below, but it is needless to say that the second prism sheet PS2 may be formed in a manner similar to the first prism sheet PS1, which will be described later. And, such a second prism sheet PS2 has a similar functional effect as the first prism sheet PS1, which will be described later.

First, the comparative example is described (for convenience, in order to avoid confusion with Example 1, “′” may be attached to a component number and the like of the comparative example). In this backlight unit 39′ of the comparative example, over a first light-reception face RS1′ of a first prism sheet PS1′, triangle prisms PR1′, which have a linear shape extending in the Y direction, are aligned along the X direction. In this first prism sheet PS1′, light is refracted by one of two side surfaces SS1a′ and SS2a′ of a surface of the triangle prism PR1′, and the light is then guided to a first outgoing face IS1′ and is emitted to outside.

Further, in the backlight unit 39′ of the comparative example, the second prism sheet PS2′ overlaps with the first outgoing face IS1′ of the first prism sheet PS1′. Accordingly, this second prism sheet PS2′ includes a second light-reception face RS2′, which receives light coming from the flat-surfaced first outgoing face IS1′ of the first prism sheet PS1′, and a second outgoing face IS2′, which emits light that has passed through this second light-reception face RS2′.

In the second prism sheet PS2′, triangle prisms PR2′, having a linear shape extending in the X direction, are aligned along the Y direction in the second light-reception face RS2′. In this second prism sheet PS2′, light is refracted by one of two side surfaces SS1b′ and SS2b′of a surface of the triangle prism PR2′, and the light is then guided to the second outgoing face IS2′ and is emitted to outside.

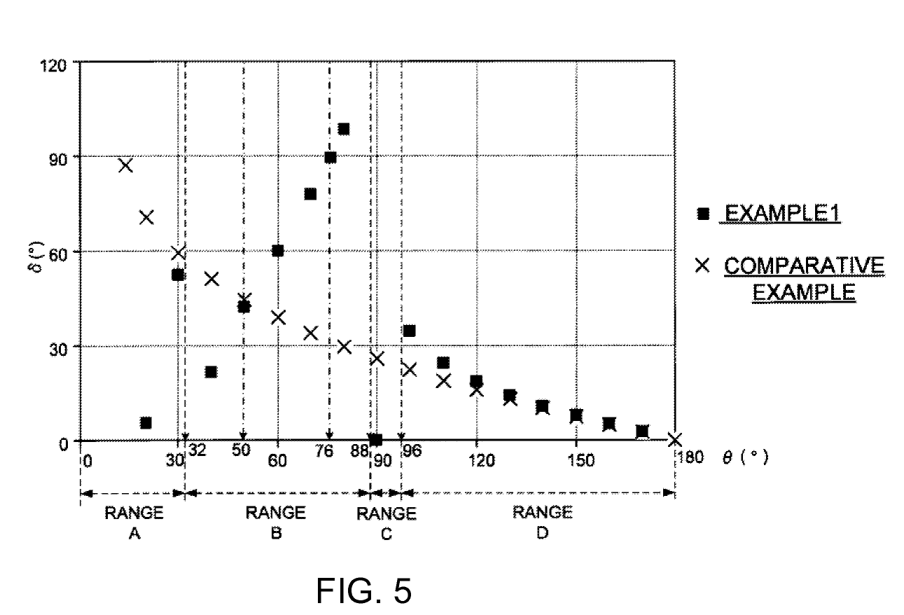

How the outgoing angle δ changes when the vertex angle θ of each triangle prism PR1 (PR1′) of the first prism sheet PS1 (PS1′) is changed will be compared between Example 1 and the comparative example (here, the vertex angle θ is an angle formed by one side surface and the other side surface in the prism). A graph showing the result of the comparison is FIG. 5 (that is, FIG. 5 is a graph showing outgoing angles δ corresponding to vertex angles θ of the triangle prism PR). Various numerical examples of Example 1 and the comparative example are as follows.

### EXAMPLE 1

The refractive index of the first prism sheet PS1 and the second prism sheet PS2=1.5
The critical angle CA at a boundary surface between the first outgoing face IS1 and air≈42(°)
The critical angle CA at a boundary surface between the second outgoing face IS2 and air)
The shortest distance D(L−R) from the LEDs 12 (light-emitting surface 12L to be precise) to the ridge line R of the prism PR1 of the first prism sheet PS1=10 (mm)
The shortest distance D(L−DS) from the LEDs 12 to a light-reception face 31B of the diffusion sheet 31=20 (mm)
The thickness of the first prism sheet PS1=2.0 (mm)
The arrangement interval of the triangle prisms PR1 in the first prism sheet PS1=0.1 (mm)
The thickness of the second prism sheet PS2=0.2 (mm)
The arrangement interval of the triangle prisms PR2 in the second prism sheet PS2=0.1 (mm)
The arrangement interval Px of the LEDs 12 in the X direction=55 (mm)
The arrangement interval Py of the LEDs 12 in the Y direction=55 (mm)

### COMPARATIVE EXAMPLE

The refractive index of the first prism sheet PS1’ and the second prism sheet PS2′=1.5
The critical angle CA at a boundary surface between the first outgoing face IS1′ and air≈42(°)
The critical angle CA at a boundary surface between the second outgoing face IS2′ and air≈42(°)
The shortest distance D (L−R) from the LEDs 12′ to the ridge line R of the ridge line R′ of the prism PR1′ in the first prism sheet PS1=10 (mm)
The shortest distance D (L-DS) from the LEDs 12′ to a light-reception face of the diffusion sheet 31=20 (mm)
The thickness of the first prism sheet PS1′=0.2 (mm)
The arrangement interval of the triangle prisms PR1′ in the first prism sheet PS1′=0.1 (mm)
The thickness of the second prism sheet PS2′=0.2 (mm)
The arrangement interval of the triangle prisms PR2′ in the second prism sheet PS2′=0.1 (mm)
The arrangement interval Px′ of the LEDs 12′ in the X direction=55 (mm)
The arrangement interval Py′ of the LEDs 12′ in the Y direction=55 (mm)

<Light Straightly Above LED>

As shown in the result of the comparative example in FIG. 5, the larger the vertex angle θ of the triangle prism PR1′ is, the smaller the outgoing angle δ becomes. This is because, as shown in FIG. 4, when light incoming nearly straight to the first prism sheet PS1′ (the first light-reception face RS1′ to be precise) from the LEDs 12′ transmits through without being totally reflected by one side surface SS1a′ of the triangle prism PR1′, the light reaches and transmits through the first outgoing face IS1′ without reaching the other side surface SS2a′ (see the dashed arrow line).

More specifically, in the comparative example, the tip of the triangle prism PR1′ points toward the side of the LEDs 12′, and therefore, the triangle prism PR1′ tapers off toward the LEDs 12′. Accordingly, when incident light to one side surface SS1a′ of the triangle prism PR1′ transmits through without being totally reflected, the transmitting light has a refractive angle smaller than the incident angle with respect to the one side surface SS1a′. Therefore, the light that has passed through the one side surface SS1a′ travels to the first outgoing face IS1′without reaching the other side surface SS2a′, which faces the one side surface SS1a′, within the triangle prism PR1′.

Further, a surface of the first outgoing face IS1′ is facing a direction same as the direction of the LED-mounted surface XY. Therefore, light coming from the one side surface SS1a′ enters the first outgoing face IS1′ at an angle inversely proportional to the size of the refractive angle with respect to the one side surface SS1a′. Then, light that transmits through the first outgoing face IS1′ is also emitted having an outgoing angle δ that is proportional to an incident angle of light entering the first outgoing face IS1′.

Accordingly, when a refractive angle with respect to one side surface SS1a′ of the triangle prism PR1′ is likely to become large, in other words, when a vertex angle θ of the triangle prism PR1′ is relatively small, the outgoing angle δ is likely to become large. On the other hand, when the vertex angle θ of the triangle prism PR1′ is relatively large, the outgoing angle δ becomes small.

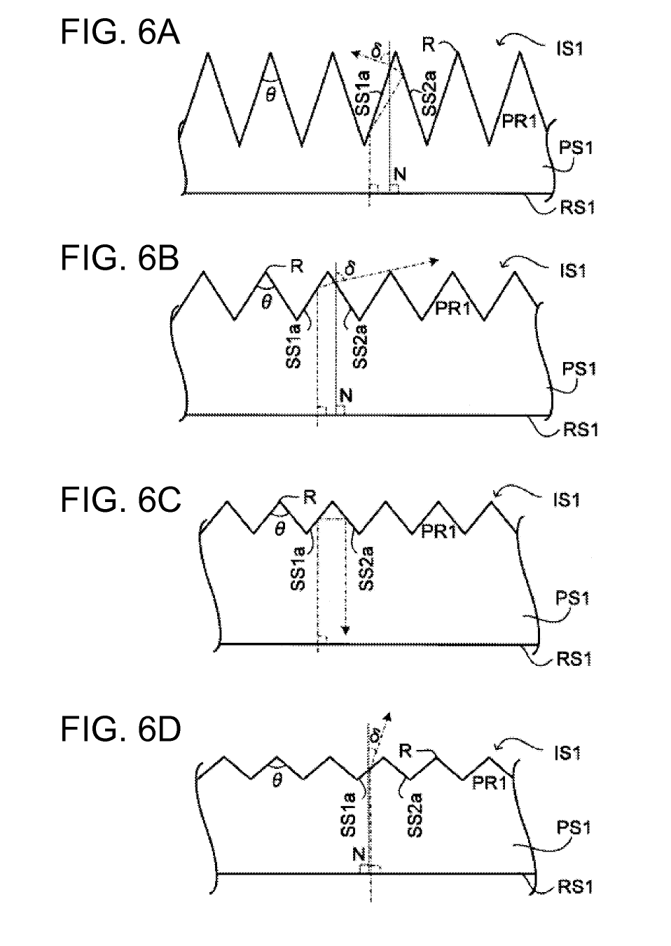

Meanwhile, in Example 1, the tip of the triangle prism (light refractive element) PR1 points toward the side of the diffusion sheet 31, and therefore, the triangle prism PR1 tapers off as it becomes distant from the LEDs 12. Therefore, as shown in FIG. 2, light that enters nearly straight to the first prism sheet PS1 (the first light-reception face RS1 to be precise) from the LEDs 12 reaches one side surface SS1a of the triangle prism PR1, and the result at light has an outgoing angle δ in accordance with the vertex angle θ as shown in FIG. 5. From the results in FIG. 5, light paths shown in FIGS. 6A to 6D (see arrow dashed lines) are understood.

FIG. 6A shows a light path in which light that has been refracted by the side surface SS1a of the triangle prism PR1 is refracted after reaching the other side surface SS2a, and travels so as to come back to the side surface SS1 a, and then continues to transmit through the side surface SS1a.

FIG. 6B shows a light path in which light that has been refracted by the side surface SS1a of the triangle prism PR1 reaches the other side surface SS2a, and continues to transmit through the other side surface SS2a.

FIG. 6C shows a light path in which light that has been refracted by the side surface SS1a of the triangle prism PR1 is refracted after reaching the other side surface SS2a, and then travels toward the first light-reception face RS1.

FIG. 6D shows a light path in which light that has been refracted by the side surface SS1a of the triangle prism PR1 continues to transmit through the side surface SS1a.

As for the triangle prism PR1 that forms the light paths shown in FIGS. 6A to 6D, the vertex angle θ becomes larger in the order of FIGS. 6A to 6D. Then, FIGS. 6A to 6D correspond to ranges A to D of the vertex angle θ in FIG. 5.

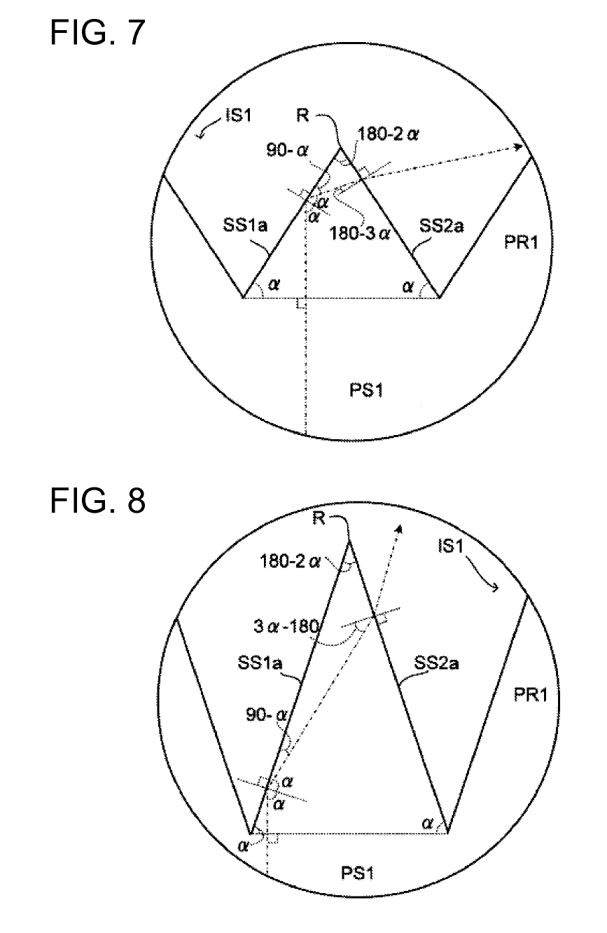

These ranges A to D of the vertex angle θ are obtained by recognizing the cross-sectional shape of the triangle prism PR1 (PR1′) as a triangle shape (that is, an isosceles triangle cross-section) with isosceles side surfaces SS1a and SS2a (SS1a′ and SS2a′), as shown in FIGS. 2 and 4, for example. Specifically, the ranges A to D of the vertex angle θ are obtained by recognizing the triangle prism PR1 (PR1′) as an isosceles triangle at an XZ surface cross-section formed by the X direction and the Z direction (see FIGS. 7 and 8).

First, a base angle of the triangle prism PR1 is called “α(°)”, and it is assumed that light entering nearly straight to the first prism sheet PS1 from the LEDs 12 is totally reflected by the side surface SS1a and then transmits through the other side surface SS2a. The light exiting from the other side surface SS2a may travel at an outgoing angle δ away from the tip of the triangle prism PR1 (see FIG. 7), or may travel at an outgoing angle δ so as to get closer to the tip of the triangle prism PR1 (see FIG. 8).

In the cases of FIGS. 7 and 8, an incident angle to the other side surface SS1a becomes “α”, which is same as the base angles. Accordingly, in order for light to be totally reflected by the other side surface SS2a, a formula below (P1) needs to be satisfied.

α≧CA (P1)

Here, CA is a critical angle (°) at a boundary surface between the side surface of the triangle prism PR1 and air.

Further, in the case of FIG. 7, an incident angle that light coming from the side surface SS1a has with respect to the other side surface SS2a is “180−3α”. Therefore, in order for light coming from the side surface SS1a to transmit through the other side surface SS2a without being totally reflected by the other side surface SS2a, a formula below (P2) needs to be satisfied.

180−3α<CA (P2)

Accordingly, the base angle α is expressed by a formula below (P3) using the critical angle CA.

α>(180−CA)/3 (P3)

In the case of FIG. 8, an incident angle that light coming from the side surface SS1a has with respect to the other side surface SS2a is “3α−180”. In order for light coming from the side surface SS1a to transmit through the other side surface SS2a without being totally reflected by the other side surface SS2a, a formula below (P4) needs to be satisfied.

3α−180<CA (P4)

Accordingly, the base angle α is expressed by a formula below (P5) using the critical angle CA.

α<(180+CA)/3 (P5)

Further, it is also possible to have a formula (P6) from the formula (P1) and the formula (P5).

CA≦α<(180+CA)/3 (P6)

A formula (P7) is derived from the formula (P3) and the formula (P5).

(180−CA)/3<α<(180+CA)/3 (P7)

When light is totally reflected by the side surface SS1a, and the totally reflected light transmits through the other side surface SS2a by this formula (P7), if the critical angle) CA≈42(°), the base angle a stays within the range below.

46(°)<α<74(°) (P8)

According to the formula (P8), the vertex angle θ of the triangle prism PR1 stays within the range of a formula below (P9). And, the range of the vertex angle θ shown in this formula (P9) corresponds to the range B in FIG. 5, and the light path corresponds to FIG. 6B.

32(°)<θ<88(°) (P9)

Moreover, if the vertex angle θ (=180−2α) in FIG. 8 becomes too small, light entering to the other side surface SS2a is totally reflected, and travels so as to come back to the side surface SS1a, and transmits through the side surface SS1a. In this case, a formula below (P10) is derived, and a formula (P11) is further derived (here, the reason for using) 90(°) in the formula (P11) is that it is impossible for an isosceles triangle to have two base angles a that are equal to or larger than 90(°)).

3α−180≧CA (P10)

(180+CA)/3≦α<α<90 (P11)

Accordingly, in the case of the formula (P11), when light is totally reflected by the side surface SS1a, and when the totally reflected light is further totally reflected by the other side surface SS2a and comes back to the side surface SS1a, and transmits through the side surface SS1a, if the critical angle CA≈42(°), the base angles a stays within the range below.

74(°)≦α<90(°) (P12)

Accordingly, from the formula (P12), the vertex angle θ of the triangle prism PR1 stays within the range of a formula below (P13). The range of the vertex angle θ shown in this formula (P13) corresponds to the range A in FIG. 5, and the light path corresponds to FIG. 6A.)

θ≦32(°) (P13)

Moreover, if the vertex angle θ (=180−2α) of FIG. 7 becomes too large, light entering to the other side surface SS2a is totally reflected, and travels toward the first light-reception face RS1. In this case, a formula below (P14) is derived, and a formula (P15) is further derived (here, a is larger than CA in the formula (P15) because if this relationship is not established, the total reflection does not occur at the side surface SS1a).

180−3α≧CA (P14)

CA≦α≦(180−CA)/3 (P15)

In the case of the formula (P15), when light is totally reflected by the side surface SS1a, and when the totally reflected light is further totally reflected by the other side surface SS2a and travels toward the first light-reception face RS1, if the critical angle CA≈42(°), the base angle α stays within the range below.)

42(°)≦α≦46(°) (P16)

Accordingly, from the formula (P16), the vertex angle θ of the triangle prism PR1 stays within the range of a formula below (P17). And, the range of the vertex angle θ shown in this formula (P17) corresponds to the range C in FIG. 5, and the light path corresponds to FIG. 6C.)

88(°)≦θ≦96(°) (P17)

Furthermore, light may transmit through the side surface SS1a without being totally reflected. In this case, because an incident angle a to the side surface SS1a is smaller than the critical angle CA (≈42°), the base angle a stays within the range of a formula below (P18).

0(°)<α<42(°) (P18)

Therefore, from the formula (P18), the vertex angle θ of the triangle prism PR1 stays within the range of a formula below (P19). And, the range of the vertex angle θ shown in this formula (P19) corresponds to the range D in FIG. 5, and the light path corresponds to FIG. 6D.

96(°)<θ<180(°) (P19)

The followings can be said from FIG. 5 and FIGS. 6A to 6D described above. Comparing Example 1 and the comparative example, when the vertex angle θ of the triangle prism PR1 is kept within the range A, the range B, and the range C, the comparative example often has a larger outgoing angle δ than Example 1.

However, in the case of the range B, if the vertex angle is equal to or larger than 50°, the outgoing angle δ of Example 1 becomes larger than the outgoing angle δ of the comparative example. In other words, when the vertex angle 0 is in the range of a formula below (A1), the outgoing angle δ of Example 1 becomes larger than the outgoing angle δ of the comparative example.

50(°)≦θ<88(°) (A1)

When the vertex angle θ is within the range of this formula (A1), incident light nearly straight to the first prism sheet PS1 travels at an angle largely inclined from the normal direction N, which overlaps the LEDs 12. As a result, the LEDs 12 are no longer noticeable from outside, and backlight light with suppressed unevenness in light amount is generated. Therefore, when the vertex angle θ is within the range of the formula (A1), the first prism sheet PS1 should have the prism surface IS1 (light refractive element surface, the first outgoing face IS1) in which the prisms PR1, which are light refractive elements, are arranged, facing not on the side of the LED-mounted surface XY, but on the opposite side.

Moreover, when the vertex angle θ is smaller than 50(°), incident light nearly straight to the first prism sheet PS1 travels at an angle largely inclined from the normal direction N, which overlaps the LEDs 12, more so in the comparative example than Example 1. However, the smaller the vertex angle θ of the triangle prism PR1 is, the more difficult it becomes to manufacture (shape forming or the like) with high accuracy (moreover, the cost is also likely to increase due to the difficulty with manufacturing). Accordingly, the backlight unit 39 of Example 1 can use a prism sheet PS that is lower in cost and easier to manufacture than the backlight unit 39 of the comparative example.

Here, in Example 1, if the outgoing angle δ is equal to or larger than 90(°), light incoming from the surface SS1a of the triangle prism PR1 travels away from the second prism sheet PS2 when it transmits through the other surface SS2a (in other words, light exiting from the other surface SS2a travels so as to get closer to the first light-reception face RS1).

Therefore, light is not likely to reach the second prism sheet PS2 directly from the other side surface SS2a. Accordingly, it is preferable to have an angle smaller than a vertex angle θ that makes 90(°) of the outgoing angle δ. Then, if a vertex angle θ corresponding to when the outgoing angle δ is 90(°) is 76(°), it is preferable that the vertex angle θ be smaller than the angle of 76(°), and therefore, a formula below (A2) is derived.

50(°)≦θ<76(°) (A2)

Furthermore, in terms of manufacturing a prism sheet PS, it is easier to manufacture ones with a larger vertex angle θ. Accordingly, it is preferable that the prism sheet PS include a plurality of triangle prisms PR having a vertex angle θ within the range of a formula below (A3). This is because the backlight unit 39 including such a prism sheet PS can easily generate backlight light with suppressed unevenness in light amount at low cost.)

65(°)≦θ<76(°) (A3)

To summarize, when the first prism sheet PS1 is included in the backlight unit 39, the triangle prisms PR1, which refract light coming from the first light-reception face RS1, are formed in the first outgoing face IS1 of the first prism sheet PS1. One surface (the side surface SS1a, for example) out of the side surfaces SS1a and SS2a of the triangle prism PR1 refracts light coming from the first light-reception face RS1, and the other side surface (the side surface SS2a, for example) refracts light coming from the one surface.

When light is transmitted between the side surfaces SS1a and SS2a this way, a prism including these side surfaces SS1a and SS2a has a shape that tapers off toward the side away from the first light-reception face RS1, such as the triangle prism PR1. Therefore, a large part of light coming from the first light-reception face RS1 is refracted twice by the two side surfaces SS1a and SS2a of the triangle prism PR formed in the first outgoing face IS1, and therefore, the amount of light that travels at an angle largely inclined from the normal direction N, which overlaps the LEDs 12, is relatively increased.

Particularly, because the ridge lines R of the triangle prisms PR1 that are aligned in the first prism sheet PS1 in the X direction extends in the Y direction, a large part of light along the X direction travels at relatively large inclination angles with respect to the normal direction N overlapping the LED 12.

Further, the triangle prisms PR2, which refract light coming from the second light-reception face RS2, are formed in the second outgoing face IS2 of the second prism sheet PS2. One surface (the side surface SS1b, for example) out of the side surfaces SS1b and SS2b of the triangle prism PR2 refracts light coming from the second light-reception face RS2, and the other side surface (the side surface SS2b, for example) refracts light coming from the one side surface.

This way, functional effects similar to those of the first prism sheet PS1 are obtained. In other words, a large part of light traveling from the second light-reception face RS2 is refracted twice by the two side surfaces SS1b and SS2b of the triangle prism PR2 formed in the second outgoing face IS2, and therefore, the amount of light that travels at relatively large inclination angles with respect to the normal direction N, which overlaps the LED 12, is relatively increased.

Particularly, because the ridge lines R of the triangle prisms PR2 that are aligned in the second prism sheet PS2 in the Y direction extend in the X direction, a large part of light along the Y direction travels at relatively large inclination angles with respect to the normal direction N, which overlaps the LED 12.

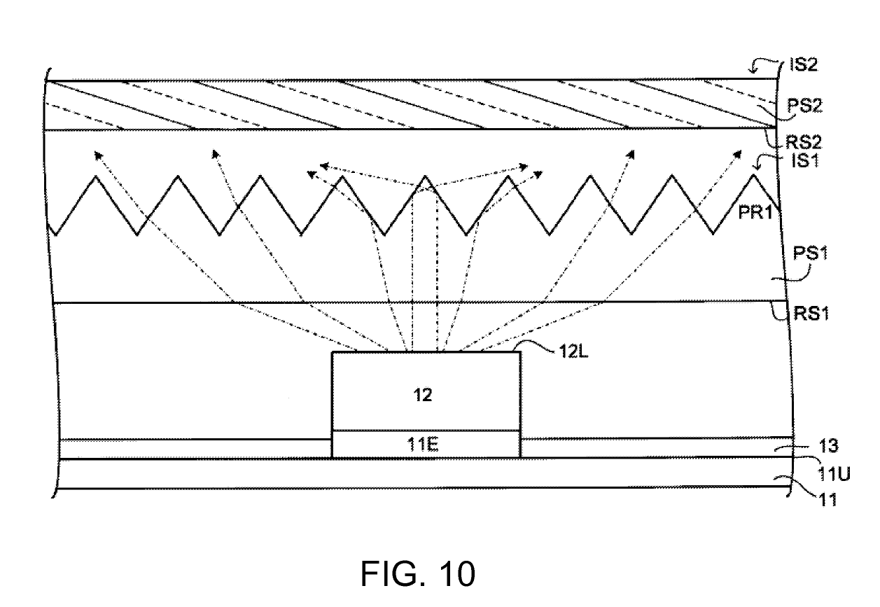

Based on the description above, if at least one of the first prism sheet PS1 and the second prism sheet PS2 is mounted in the backlight unit 39, light that travels at relatively large inclination angles with respect to the normal direction N, which overlaps the LED 12, is increased. That is, light straightly above the LEDs 12 or the like is no longer noticeable from the outside, and backlight light with suppressed unevenness in light amount is generated (see FIG. 10, which will be described later).

<Peripheral Light From LED>

A description was made above on how incident light nearly straightly above the first prism sheet PS1 (light directly above) is refracted by the triangle prisms PR1. This is because such light (light that travels nearly straight from the light emitting surface 12L of the LEDs 12; light directly above) is likely to become a cause for unevenness in light amount because it has relatively high light intensity among light emitted from the LEDs 12.

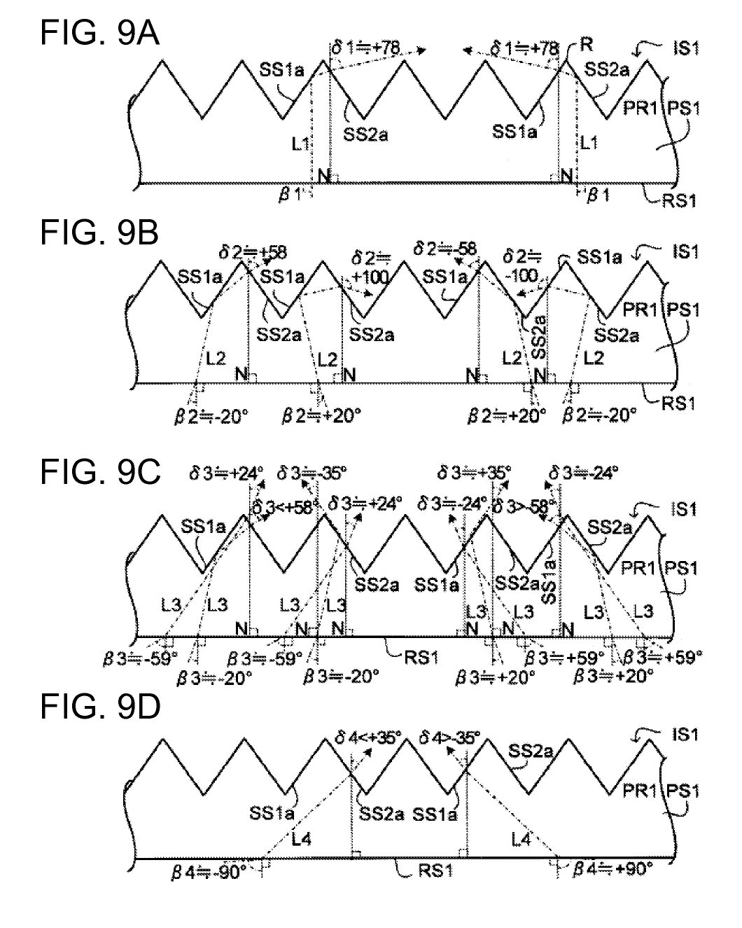

However, the LEDs 12 also emit light other than the straight light (peripheral light). Here, by using FIGS. 9A to 9D, a description is made on when such peripheral light enters the first prism sheet PS1. Further, numerical values for the backlight unit 39 for these figures are similar to the examples of numerical values of the above-described Example 1. Here, the vertex angle θ of the triangle prism PR1 is 70(°). For convenience, the vertex angle θ and the outgoing angle δ in these figures may be assigned with a character such that one side of the normal direction N (the right side on the paper) is “+”, and the other side (the left side on the paper) is “−”.

First, as shown in FIG. 9A, light L1 entering nearly straight to the first prism sheet PS1 (the first light-reception face RS1 to be precise) is totally reflected by one side surface SS of the triangle prism PR1, and then transmits through the other side surface SS. An outgoing angle (refractive angle) δ1 of light when exiting from the other side surface SS is shown in a formula below (Q1).

δ1≈|78(°)| formula (Q1)

Here, it is preferable that an incident angle β1 to the first light-reception face RS1 be β1≈±0(°).

Meanwhile, as shown in FIG. 9B, light L2, which enters the first prism sheet PS1 at an incident angle β2 of approximately 20(°) in absolute value, is totally reflected by one side surface SS of the triangle prism PR1, and then transmits through the other side surface SS in a similar way as the light L1. However, the value of an outgoing angle δ2 changes in accordance with the incident angle to the side surface SS.

To explain in more detail, the value of the outgoing angle δ2 is different between when light enters a side surface SS that has a relatively small inclination with respect to the incident direction of light to the first light-reception face RS1 (side surface that follows the incident direction), and when light enters to a side surface SS that has a relatively large inclination with respect to the incident direction of light to the first light-reception face RS1.

Specifically, when light enters the side surface SS that has a relatively small inclination with respect to the incident direction of light to the first light-reception face RS1, the outgoing angle δ2 becomes approximately 58(°) in absolute value. On the other hand, when light enters the side surface SS that has a relatively large inclination with respect to the incident direction of light to the first light-reception face RS1, the outgoing angle δ2 becomes approximately 100(°) in absolute value.

Therefore, a formula (Q2) and a formula (Q2′) below are derived.

δ2≈|58(°)| formula (Q2)

δ2≈|100(°)| formula (Q2′)

Further, when the formula (Q2) and the formula (Q2′) are established, it is preferable that the incident angle β2 to the first light-reception face RS1 be 0(°)<β2≦|20(°)|.

Next, as shown in FIG. 9C, light L3 that enters the first prism sheet PS1 at an incident angle β3 that is larger than 20(°) and is approximately 59(°) in absolute value is described as follows.

When the light L3 enters one of the side surfaces SS of the triangle prism PR1 at an incident angle β3 of slightly larger than 20(°) in absolute value, the value of the outgoing angle δ3 becomes different between when light enters the side surface SS that has a relatively small inclination with respect to the incident direction of light to the first light-reception face RS1, and when light enters the side surface SS that has a relatively large inclination with respect to the incident direction of light to the first light-reception face RS1.

Specifically, when light enters the side surface SS that has a relatively small inclination with respect to the incident direction of light to the first light-reception face RS1, the outgoing angle δ3 becomes less than 58(°) in absolute value. On the other hand, when light enters the side surface SS that has a relatively large inclination with respect to the incident direction of light to the first light-reception face RS1, the outgoing angle δ3 becomes approximately 35(°) in absolute value.

Further, when the light L3 enters one of the side surfaces SS of the triangle prism PR1 at the incident angle β3 of approximately 59(°) in absolute value, regardless of which one of the side surfaces SS, the light L3 transmits through the side surface SS at an outgoing angle of approximately 24(°) in absolute value.

As a result, a formula below (Q3) is derived.

|24(°)|≦δ3<|58(°)| formula (Q3)

Further, when the formula (Q3) is established, it is preferable that the incident angle β3 to the first light-reception face RS1 satisfy |20(°)|<β3≦|59(°)|.

Next, as shown in FIG. 9D, light L4 incident to the first prism sheet PS1 at an incident angle β4 of larger than 59(°) in absolute value enters one of the side surfaces SS of the triangle prism PR1, and then transmits through the side surface SS at an outgoing angle δ4 of smaller than 35(°) in absolute value without being totally reflected.

As a result, a formula below (Q4) is derived.

|24(°)|<δ4<|35(°)| formula (Q4)

Further, when the formula (Q4) is established, it is preferable that the incident angle β4 to the first light-reception face RS1 satisfy |59(°)|<β3<|90(°)|.

To summarize, as shown in FIGS. 9A and 9B, when the incident angle β is equal to or less than 20(°) in absolute value, for example, when light straightly above the LEDs 12 (light with relatively high light intensity) exits from the first prism sheet PS1, the light is directed away the LEDs 12 with certainty (light exits the first prism sheet PS1 at the outgoing angle δ of equal to or larger than 58(°) in absolute value). Therefore, in the planar light, the luminance (light density) of a region overlapping with the LEDs 12 is suppressed while increasing the luminance of a region overlapping with a gap between LEDs 12.

Meanwhile, as shown in FIGS. 9C and 9D, in the case where the incident angle β is larger than 20(°) in absolute value, for example, when light (peripheral light; light with relatively low light intensity) other than light straightly above the LEDs 12 exits from the first prism sheet PS1, the light exits at an outgoing angle δ of smaller than 58(°) in absolute value (a large part of the light exits at an outgoing angle δ of smaller than 35(°) in absolute value, to be precise).

This outgoing angle δ is smaller than the outgoing angle δ when the incident angle β is smaller than 20(°) in absolute value. However, as shown in FIG. 10 (a figure showing a part of the light paths shown in FIGS. 9A to 9D along with one LED 12), compared to the light directly above the LED 12, peripheral light is directed away from the LED 12 before it reaches the first prism sheet PS1.

Therefore, even though the outgoing angle δ of the peripheral light is relatively small, the peripheral light reaches a region overlapping with the gaps between the LEDs 12 after it exits the first prism sheet PS1, and thereby increasing the luminance. Accordingly, the unevenness in light amount can be suppressed in the backlight unit 39 that includes the first prism sheet PS1 in which the prism surface IS1(the first outgoing face IS1) is not facing the LED-mounted surface XY, but facing the other side (the diffusion sheet 31).

<Distance Between LED and Prism Sheet>

Here, light from the LEDs 12 is usually diverged. Therefore, if the distance between the LEDs 12 and the prism sheet PS is too small, the shape of the LEDs 12 is reflected in the prism sheet PS, and thereby causes deterioration of the quality of the backlight light (that is, the luminance uniformity of planar light is deteriorated).

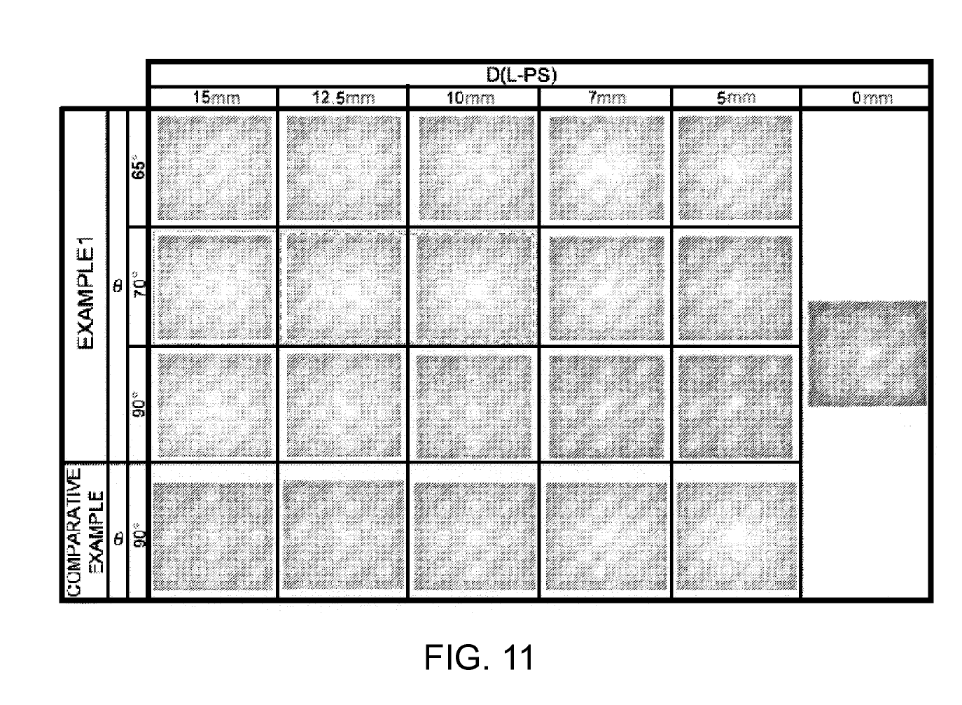

Here, Example 1 and the comparative example described above will be compared on the following conditions. To explain in more detail, images in which the luminance uniformity of planar light is recognizable are obtained and compared on the following conditions. And, the result is shown in FIG. 11.

### EXAMPLE 1

The shortest distance D (L−R) from the LEDs 12 (the light emitting surface 12L to be precise) to the ridge line R of the prisms PR1 in the first prism sheet PS1 is changed to 0, 5, 7, 10, 12.5, and 15 (mm). Here, 0 (mm) means that the LEDs 12 and the first prism sheet PS1 are in close contact with each other.
The vertex angle θ of the prisms PR2 in the first prism sheet PS1 and the second prism sheet PS2 is changed to 65(°), 70(°), and 90(°).

### COMPARATIVE EXAMPLE

The shortest distance D(L−R) from the LEDs 12′ to the ridge line R′ of the prism PR1′ in the first prism sheet PS1′ is changed to 0, 5, 7, 10, 12.5, and 15 (mm). Here, 0 (mm) means that the LEDs 12′ and the first prism sheet PS1′ are in close contact with each other.
The vertex angle θ of the triangle prism PR′ (PR1′ and PR2′) in the first prism sheet PS1′ and the second prism sheet PS2′ is fixed to 90(°).

As shown in FIG. 11, in both Example 1 and the comparative example, when the shortest distance D(L−R) between the LEDs 12 and the ridge line R of the prism PR1 is 0 (mm), the LEDs 12 are reflected in the planar light, and therefore, the luminance uniformity is determined to be low.

Moreover, even when the shortest distance D(L−R) is 5 (mm), the LEDs 12 are reflected in the planar light in both Example 1 and the comparative example, and therefore, the luminance uniformity is determined to be low.

Also, when the shortest distance D(L−R) is 7 (mm), the LEDs 12 are reflected in planar light when the vertex angle θ is 65(°) or 90(°) in Example 1, and in the comparative example, and therefore, the luminance uniformity is determined to be low. However, when the vertex angle θ is 70(°) in Example 1, the LEDs 12 are not reflected as much as the other cases.

Further, in FIG. 11, in the area surrounded by a dashed line rectangular, that is, when the vertex angle θ is 70(°) and the shortest distance D (L−R) is 10 (mm), 12.5 (mm), or 15 (mm) in Example 1, the reflection of the LEDs 12 is further suppressed compared to when the vertex angle θ is 70(°) and the shortest distance D(L−R) is 7 (mm) in Example 1 (on the other hand, the LEDs 12 are reflected distinctively when the vertex angle θ is in other values in Example 1 and in the comparative example). Particularly, when the vertex angle θ is 70(°) and the shortest distance D(L−R) is 10 (mm) or 12.5 (mm) in Example 1, the LEDs 12 are barely reflected, and the luminance uniformity becomes very high (see the dashed line rectangular).

Furthermore, although not shown in FIG. 11, when the vertex angle θ is 70(°) and the shortest distance D(L−R) is 20 (mm) in Example 1, planar light that is approximately at the same level as when the vertex angle θ is 70(°) and the shortest distance D(L−R) is 7 (mm) in Example 1 is obtained.

From the result of Example 1 described above, a formula below (B1) is derived. That is, when a range satisfies the formula below (B1), the unevenness in luminance of planar light can be suppressed.

0.35<D(L−R)/D(L−DS)<1 formula (B1)

Here,
D(L−R) means the shortest distance from the LEDs 12 to the ridge line R of the prism PR1 in the first prism sheet PS1
D(L−DS) means the shortest distance from the LEDs 12 to the light-reception face 31B of the diffusion sheet 31.

Further, when the formula below (B2) is satisfied, the unevenness in luminance of planar light is even more suppressed, and when the formula below (B3) is further satisfied, the unevenness in luminance of planar light is suppressed with certainty.

0.5≦D(L−R)/D(L−DS)≦0.75 formula (B2)

0.5≦D(L−R)/D(L−DS)≦0.625 formula (B3)

<Refractive Index>

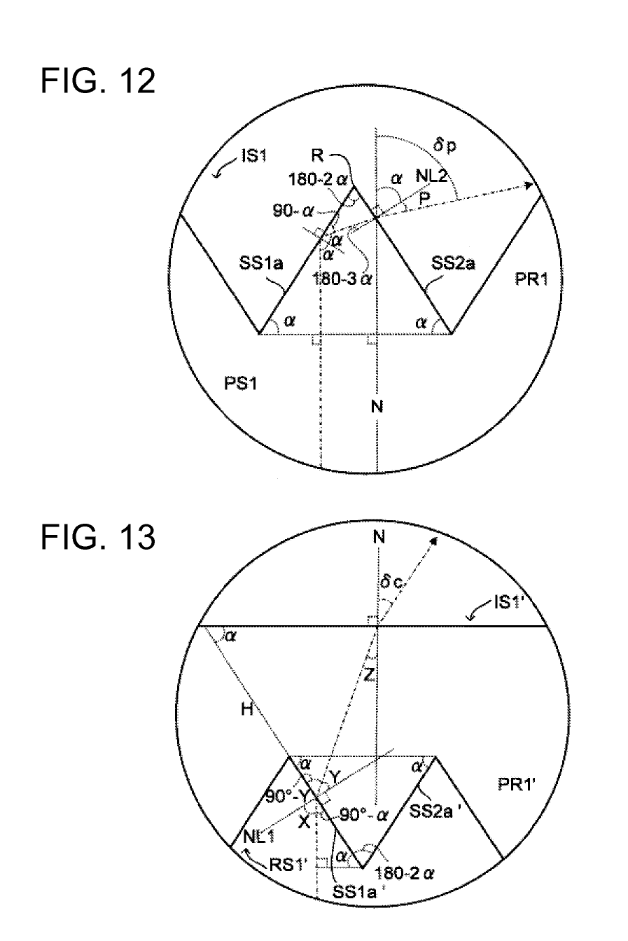

The first prism sheet PS1 and the second prism sheet PS2 with a refractive index of 1.5 were described above as an example. However, the refractive index (n) is not limited to this value. Here, light straightly above the LEDs 12 is described by using new figures FIGS. 12 and 13, which are based on FIG. 2 (Example 1) and FIG. 4 (comparative example). FIG. 12 is based on FIG. 2, and FIG. 13 is based on FIG. 4 (however, the refractive index of a prism sheet shown in FIGS. 12 and 13 is not particularly limited).

The vertex angle θ and the base angles a of the triangle prism PR1 in the first prism sheet PS1 in FIG. 12 have the same values as the vertex angle θ and the base angles α of the triangle prism PR1′ in the first prism sheet PS1′ in FIG. 13.

As shown in FIG. 12, an angle that light existing from the first prism sheet PS1 has with respect to the normal direction NL2 of the side surface SS2a of the triangle prism PR is called a refractive angle P, and an outgoing angle δ (an angle that light has with respect to the normal direction N to a sheet surface direction of the first prism sheet PS1) of the exiting light is called an outgoing angle δp. An angle formed by the normal direction NL2 with respect to the side surface SS2a of the triangle prism PR and by the normal direction N with respect to the sheet surface direction of the first prism sheet PS1 is the same angle as the base angle α of the triangle prism PR.

Usually, at a boundary surface of different mediums, Snell's law is established. Accordingly, in the case of the first prism sheet PS1 shown in FIG. 12, a formula below (E1) is established.

[Formula E1]

1·sin P=n·sin (180°−3α) (E1)

Thus, a formula below (E2) can be obtained from this formula (E1).

[Formula E2]

P=sin⁻¹{n·sin (180°−3α)} (E2)

Moreover, the outgoing angle δp is a total of the base angle α and the refractive angle P as shown in FIG. 12, and therefore, a formula below (E3) is obtained. Here, the formula (E3) is expressed using the vertex angle θ (=180−2α).

$$\begin{matrix}[ Formula E 3 ] & \\ \begin{matrix}δ p = α + P \\ = ( 90 ° - \frac{θ}{2} ) + {sin}^{- 1} \{ n \cdot sin ( 180 ° - 3 α ) \} \\ = ( 90 ° - \frac{θ}{2} ) + {sin}^{- 1} [ n \cdot sin \{ 180 ° - 3 \cdot ( 90 ° - \frac{θ}{2} ) \} ]\end{matrix} & ( E3 )\end{matrix}$$

Meanwhile, in the first prism sheet PS1′ shown in FIG. 13, angles are defined as follows. That is, in the first prism sheet PS1′, an angle with respect to the normal direction NL1 of the side surface SS1a′ of the triangle prism PR1′ included in the first light-reception face RS1′ is called an incident angle X, a refractive angle at the side surface SS1a′ of incident light at the incident angle X is called a refractive angle Y, an angle that light traveling at the refractive angle Y has when entering to the light outgoing face IS1′ is called an incident angle Z, and an outgoing angle of light when existing the first outgoing face IS1′ of the first prism sheet PS1′ is called an outgoing angle δc. 101481 Accordingly, as shown in FIG. 13, an external surface of the side surface SS1a′ with respect to a horizontal surface is the same angle as the base angle α of the triangle prism PR1′, and therefore, the incident angle X with respect to the normal direction NL1 of the side surface SS1a′ is the same angle as the base angle α.

Furthermore, according to Snell's law, the formula below (E4) is established, and the refractive angle Y satisfies the formula below (E5).

$$\begin{matrix}[ Formula E 4 ] & \\ 1 \cdot sin α = n \cdot sin Y & ( E4 ) \\ [ Formula E 5 ] & \\ Y = {sin}^{- 1} ( \frac{sin α}{n} ) & ( E5 )\end{matrix}$$

If an auxiliary surface that reaches the first outgoing face IS1′ of the first prism sheet PS1′ and that extends from the side surface SS1a′ is formed, an angle formed by the auxiliary surface and the first outgoing face IS1′ within the first prism sheet PS1′ becomes the same angle as the base angle α. Accordingly, from this angle α, and an angle “90°-Y” that is an angle formed by light traveling toward the light outgoing face IS1′ at the refractive angle Y and by the side surface SS1a′, the incident angle Z satisfies a formula below (E6).

$$\begin{matrix}[ Formula E 6 ] & \\ Z = α - {sin}^{- 1} ( \frac{sin α}{n} ) & ( E6 )\end{matrix}$$

Accordingly, between the incident light of the incident angle Z and the outgoing light of the outgoing angle δc, a formula (E7) according to Snell's law is established, and the outgoing angle δc can be obtained by a formula below (E8).

$$\begin{matrix}[ Formula E 7 ] & \\ n \cdot sin \{ α - {sin}^{- 1} ( \frac{sin α}{n} ) \} - 1 \cdot sin δ & ( E7 ) \\ [ Formula E 8 ] & \\ \begin{matrix}δ c = {sin}^{- 1} [ n \cdot sin \{ α - {sin}^{- 1} ( \frac{sin α}{n} ) \} ] \\ = {sin}^{- 1} [ n \cdot sin \{ ( 90 ° - \frac{θ}{2} ) - {sin}^{- 1} ( \frac{sin ( 90 ° - \frac{θ}{2} )}{n} ) \} ]\end{matrix} & ( E8 )\end{matrix}$$

When comparing the outgoing angle δp and the outgoing angle δc described above, the followings can be said. That is, as described above (see FIG. 5), it is preferable that the outgoing angle δp of light from the first prism sheet PS1 shown in FIG. 12 be larger than the first prism sheet PS1′ shown in FIG. 13 (δp>δc). Accordingly, a formula below (F1) is derived.

$$\begin{matrix}[ Formula F 1 ] & \\ ( 90 ° - \frac{θ}{2} ) + {sin}^{- 1} [ n \cdot sin \{ 180 ° - 3 \cdot ( 90 ° - \frac{θ}{2} ) \} ] > {sin}^{- 1} [ n \cdot sin \{ ( 90 ° - \frac{θ}{2} ) - {sin}^{- 1} ( \frac{sin ( 90 ° - \frac{θ}{2} )}{n} ) \} ] & ( F1 )\end{matrix}$$

Further, as described above (see FIG. 5), it is preferable that the outgoing angle δp be smaller than 90°. This way, a formula below (F2) is also led.

$$\begin{matrix}[ Formula F 2 ] & \\ 90 ° > ( 90 ° - \frac{θ}{2} ) + {sin}^{- 1} [ n \cdot sin \{ 180 ° - 3 \cdot ( 90 ° - \frac{θ}{2} ) \} ] > {sin}^{- 1} [ n \cdot sin \{ ( 90 ° - \frac{θ}{2} ) - {sin}^{- 1} ( \frac{sin ( 90 ° - \frac{θ}{2} )}{n} ) \} ] & ( F2 )\end{matrix}$$

And, when the backlight unit 39 is mounted with at least one prism sheet that satisfies the formula (F1) or the formula (F2) described above (that is, at least either the first prism sheet PS1 that satisfies the formula (F1) or the formula (F2), or the second prism sheet PS2 that satisfies the formula (F1) or the formula (F2) is mounted) light that travels at relatively large inclination angles with respect to the normal direction N, which overlaps the LED 12, is increased as described above. As a result, light straightly above the LEDs 12 and the like becomes no longer noticeable from outside, and backlight light with suppressed unevenness in light amount is generated.

### Embodiment 2

Embodiment 2 will be described. Here, members having the similar functions as the members used in Embodiment 1 are assigned with the same reference characters, and the description of them is omitted.

In Example 1 of Embodiment 1, the arrangement interval (arrangement pitch) of the LEDs 12 was same in the X direction and the Y direction (Px=Py=55 (mm)). Here, in Embodiment 2, two examples in which the arrangement interval of the LEDs 12 is different in the X direction and in the Y direction (Example 2 and Example 3) are described. A difference between Example 2 and Example 3 is that the alignment direction of the triangle prisms PR1 in the first prism sheet PS1 is different, and the alignment direction of the triangle prisms PR2 in the second prism sheet PS2 is also different.

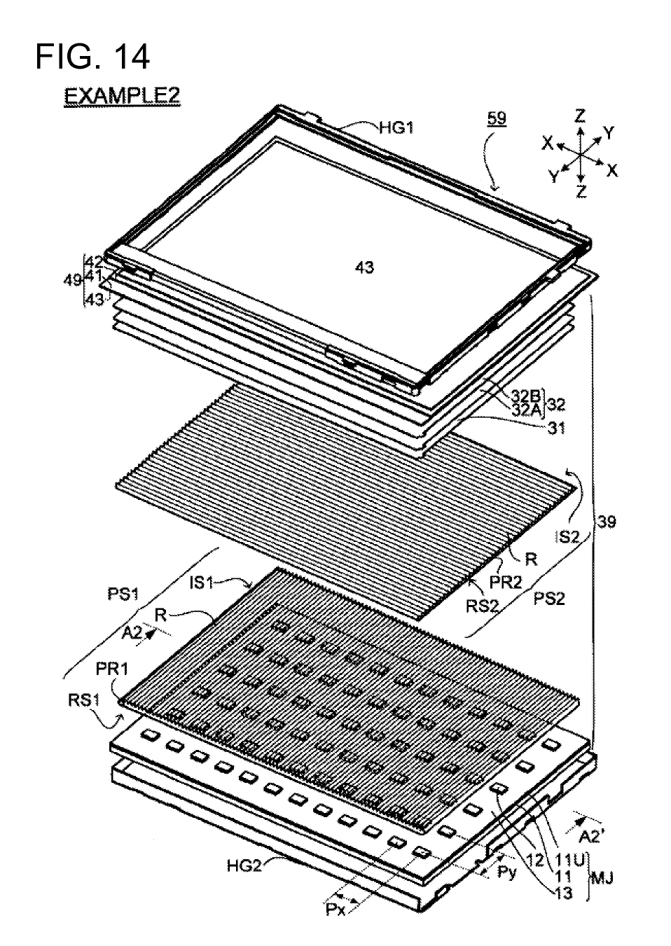

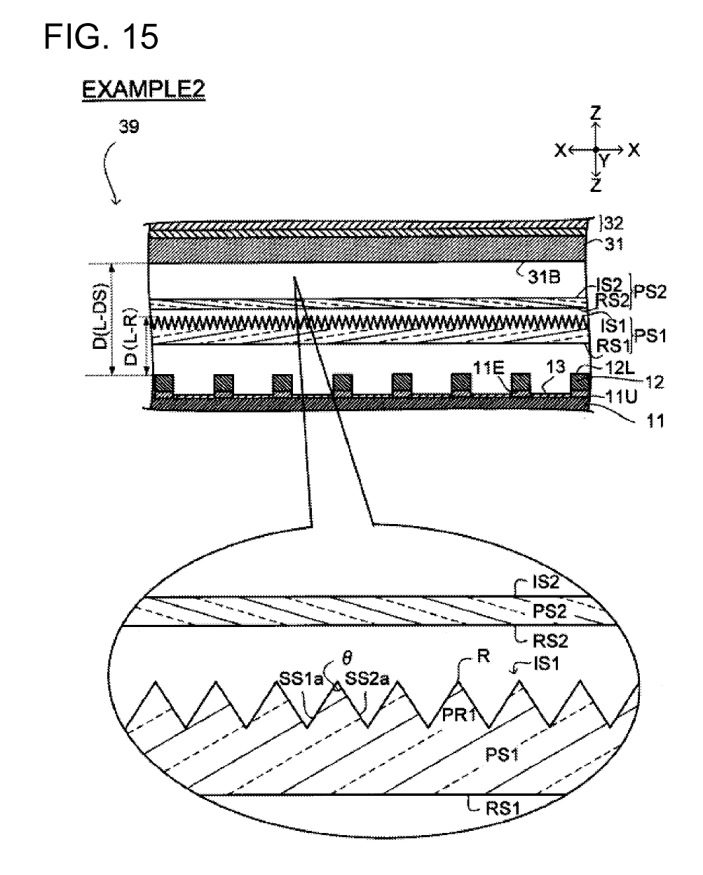

To explain in more detail, in Example 2, as shown in FIGS. 14 and 15 (the cross-sectional arrow view along the line A2-A2′ of FIG. 14), the first prism sheet PS1 has the triangle prisms PR1, which have a linear shape extending in the Y direction, aligned in the first outgoing face IS1 along the X direction. Moreover, the second prism sheet PS2 has the triangle prisms PR2, which have a linear shape extending in the X direction, aligned in the second outgoing face IS2 along the Y direction.

That is to say, in Example 2 and Example 1, the extending directions (direction of the ridge line R) of the triangle prisms PR1 and PR2 in the first prism sheet PS1 and the second prism sheet PS2 are the same, and the alignment directions of the triangle prisms PR1 and PR2 are also the same.

However, the ridge lines R of the triangle prisms PR1 in the first prism sheet PS1 become perpendicular to the X direction, which is the direction of the shorter arrangement interval of the LEDs 12, and the ridge lines R of the triangle prisms PR2 in the second prism sheet PS2 become perpendicular to the Y direction, which is the direction of the longer arrangement interval of the LEDs 12 (in other words, the alignment direction of the triangle prisms PR1 in the first prism sheet PS1 is the same direction as the'X direction, which is the direction of a short arrangement interval, and the alignment direction of the triangle prisms PR2 in the second prism sheet PS2 is the same direction as the Y direction, which is the direction of a long arrangement interval).

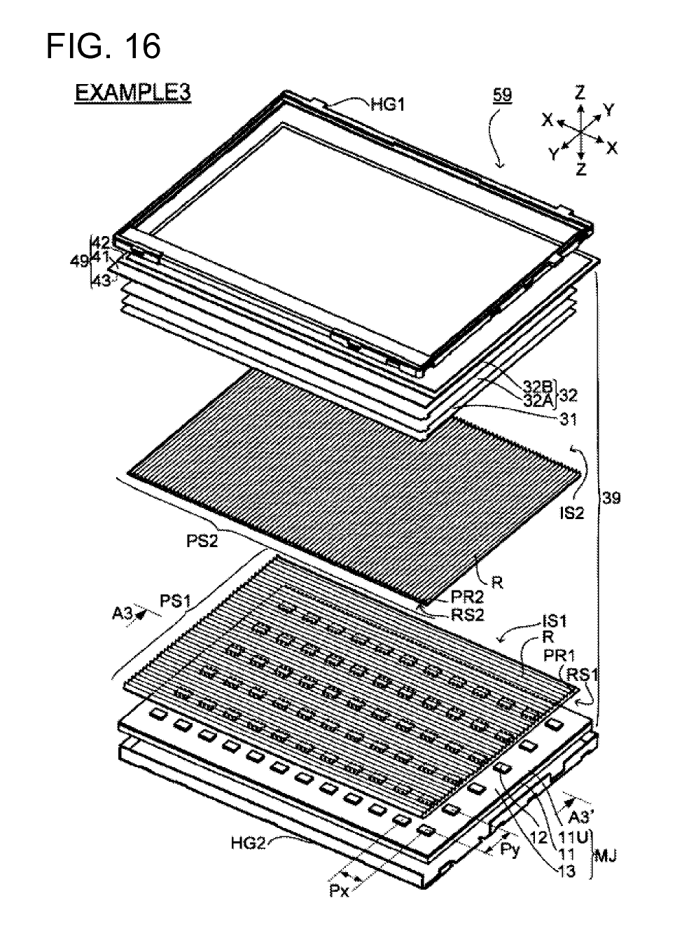

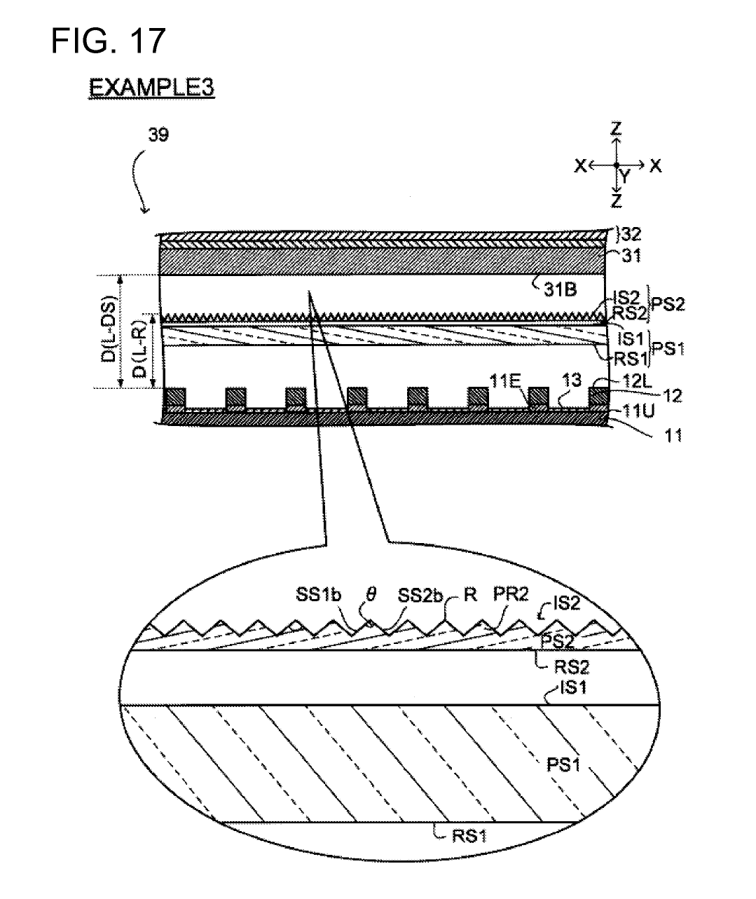

Meanwhile, in Example 3, as shown in FIGS. 16 and 17 (the cross-sectional arrow view along the line A3-A3′ in FIG. 16), the first prism sheet PS1 has the triangle prism PR1, which have a linear shape extending in the X direction, aligned in the first outgoing face IS1 along the Y direction. The second prism sheet PS2 has the triangle prisms PR2, which have a linear shape extending in the Y direction, aligned in the second outgoing face IS2 along the X direction.

That is, the extending direction of the triangle prisms PR1 as well as the alignment direction of the triangle prisms PR1 in the first prism sheet PS1 of Example 3 become perpendicular to (cross) the extending direction of the triangle prisms PR1 as well as the alignment direction of the triangle prisms PR1 in the first prism sheet PS1 of Example 2.

Similarly, the extending direction of the triangle prisms PR2 as well as the alignment direction of the triangle prisms PR2 in the second prism sheet PS2 of Example 3 become perpendicular to (cross) the extending direction of the triangle prisms PR2 as well as the alignment direction of the triangle prisms PR2 in the second prism sheet PS2 of Example 2.

Further, the ridge lines R of the triangle prisms PR1 in the first prism sheet PS1 become perpendicular to the Y direction, which is the direction of a long arrangement interval of the LEDs 12, and the ridge lines R of the triangle prisms PR2 in the second prism sheet PS2 become perpendicular to the X direction, which is the direction of a short arrangement interval of the LEDs 12 (in other words, the alignment direction of the triangle prisms PR1 in the first prism sheet PS1 is in the same direction as the Y direction, which is the direction of a long arrangement interval of the LEDs 12, and the alignment direction of the triangle prisms PR2 in the second prism sheet PS2 is in the same direction as the X direction, which is the direction of a short arrangement interval of the LEDs 12).

Numeral examples that are common in Example 2 and Example 3 are as follows.

### EXAMPLE 2, EXAMPLE 3

The refractive index of the first prism sheet PS1 and the second prism sheet PS2=1.5
The critical angle CA at a boundary surface between the first outgoing face IS1 and air=≈42(°)
The critical angle CA at a boundary surface between the second outgoing face IS2 and air≈42(°)
The shortest distance D(L−R) from the LEDs 12 (the light emitting surface 12L to be precise) to the ridge lines R of the prisms PR1 in the first prism sheet PS1=10 (mm)
The shortest distance D(L−DS) from the LEDs 12 to the light reception face 31B of the diffusion sheet 31=20 (mm)
The thickness of the first prism sheet PS1=2.0 (mm)
The vertex angle θ of the triangle prism PR1 in the first prism sheet PS1=70(°)
The arrangement interval of the triangle prisms PR1 in the first prism sheet PS1=0.1 (mm)
The thickness of the second prism sheet PS2=0.2 (mm)
The vertex angle θ of the triangle prism PR2 in the second prism sheet PS2=70(°)
The arrangement interval of the triangle prisms PR2 in the second prism sheet PS2=0.1 (mm)
The arrangement interval Px of the LEDs 12 in the X direction=48 (mm)
The arrangement interval Py of the LEDs 12 in the Y direction=55 (mm)

In Example 2 and Example 3 described above, similarly to Example 1, the first prism sheet PS1 has the triangle prisms PR1, which refract light coming from the first light-reception face RS1, formed in the first outgoing face IS1, and one surface (SS1a, for example) of the side surfaces SS1a and SS2a of the triangle prism PR1 refracts light coming from the first light-reception face RS1, and the other side surface (SS2a, for example) refracts light coming from the one side surface.

Moreover, in Example 2 and Example 3, similarly to Example 1, the second prism sheet PS2 has the triangle prisms PR2, which refract light coming from the second light-reception face RS2, formed in the second outgoing face 152, and one surface (SS1b, for example) of the side surfaces SS1b and SS2b of the triangle prism PR2 refracts light coming from the second light-reception face RS2, and the other side surface (SS2b, for example) refracts light coming from the one side surface.

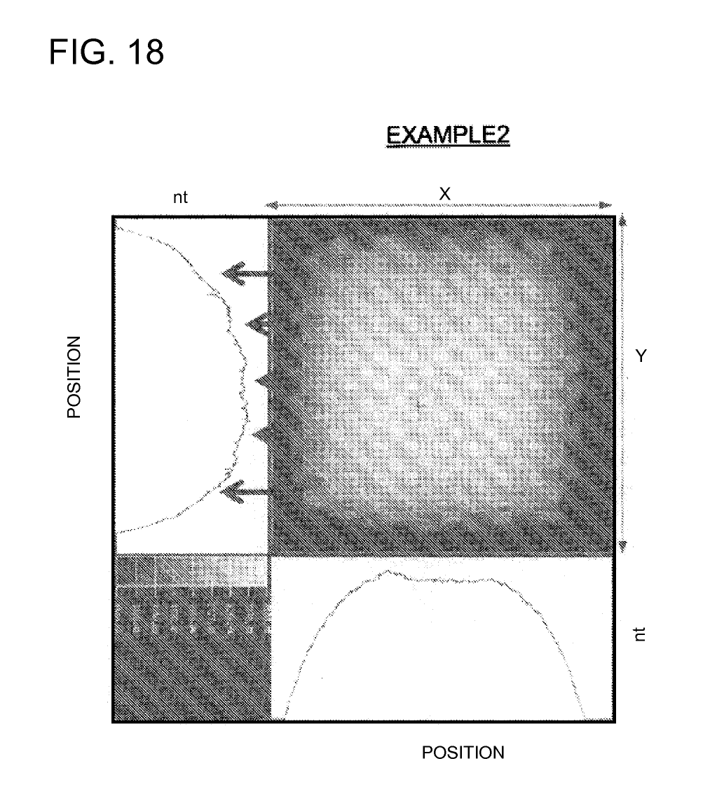

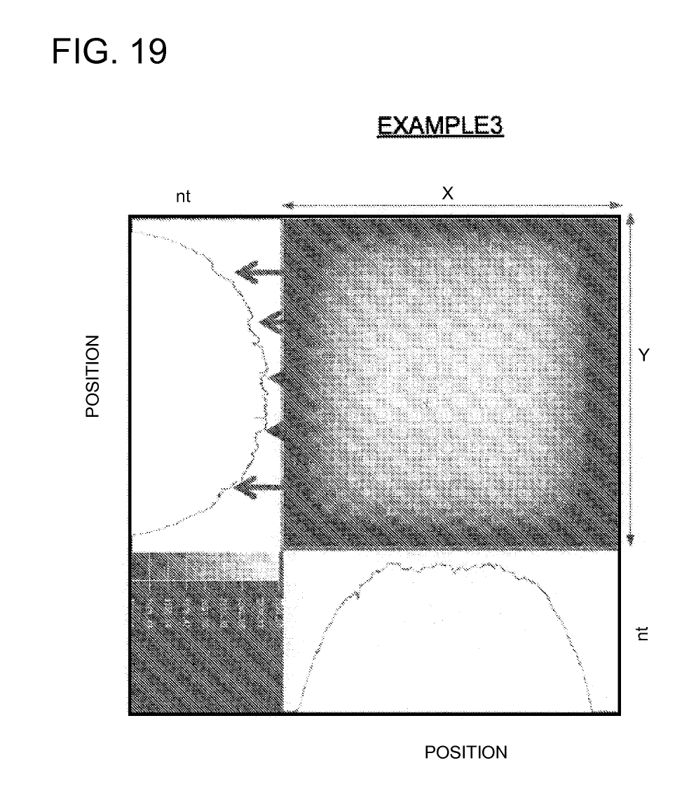

Therefore, Example 2 and Example 3 have functional effects similar to those of Example 1. However, when Example 2 and Example 3 are compared, there is a difference between them. FIGS. 18 and 19 show the difference. There figures show an image in which the luminance uniformity of planar light is recognizable, and a graph showing positions and luminance (nt) per direction of two directions perpendicular to each other in the image (FIG. 18 corresponds to Example 2, and FIG. 19 corresponds to Example 3).

When FIG. 18, which is Example 2, and FIG. 19, which is Example 3, are compared, the followings become clear. To explain details, when comparing a graph showing the luminance along the Y direction in Example 2 and a graph showing the luminance along the Y direction of Example 3, in areas shown by arrows in the graphs, an area with a lowered luminance was formed in Example 3, and such an area with a lowered luminance is not formed in Example 2 (in other words, recessed areas are not formed in the curved graph line of Example 2, but the recessed areas are formed in a part of the curved graph line of Example 3).

Such an area with a lowered luminance in Example 3 is called a dark line, and it is one example of unevenness in light amount of planar light. In the LEDs 12 arranged in a matrix, when the arrangement interval of the LEDs 12 along one of the two directions (X direction and Y direction), which are perpendicular to each other, is different from the arrangement interval of the LEDs 12 along the other direction, such a dark line is likely to occur along the direction of the shorter arrangement interval.

The reason is that, when the arrangement interval is long, light of the LEDs 12 is not likely to reach near the center of the arrangement interval, and an area darker than the surrounding area is created, and that area is further aligned in the direction along the shorter arrangement interval.

In order to resolve such a dark line, light should be spread all the way in the direction along the longer arrangement interval on a side that is as close as possible to a viewer of planar light. And, an example in which such a measure was implemented is Example 2.

That is, in Example 2, the triangle prisms PR2 of the second prism sheet PS2, which is located on a side as close as possible to a viewer of planar light, become perpendicular to the Y direction, which is a direction of the long arrangement interval, and light is spread along the Y direction (the point is that, by making the ridge lines R of the triangle prisms PR2 in the second prism sheet PS2 become perpendicular to the Y direction, light is spread along the Y direction). This way, an area darker than the surrounding area is eliminated in the arrangement interval of the LEDs along the Y direction, and furthermore, a dark line is not formed in the X direction, which is the direction along the short arrangement interval.

On the other hand, in Example 3, the triangle prisms PR2 of the second prism sheet PS2 is perpendicular to the X direction, which is the direction of the short arrangement interval so that light is spread along the X direction, and light is not fully spread in the Y direction. Therefore, an area darker than the surrounding area is formed in the arrangement interval of the LEDs 12 along the Y direction, and further, a dark line is formed in the X direction, which is the direction along the short arrangement interval. However, even though some dark lines are formed in Example 3, unevenness in light amount is more suppressed than the comparative example.

### Embodiment 3

Embodiment 3 is described. Here, members having a similar function as the members used in Embodiments 1 and 2 are attached with the same reference characters, and the description of them are omitted.

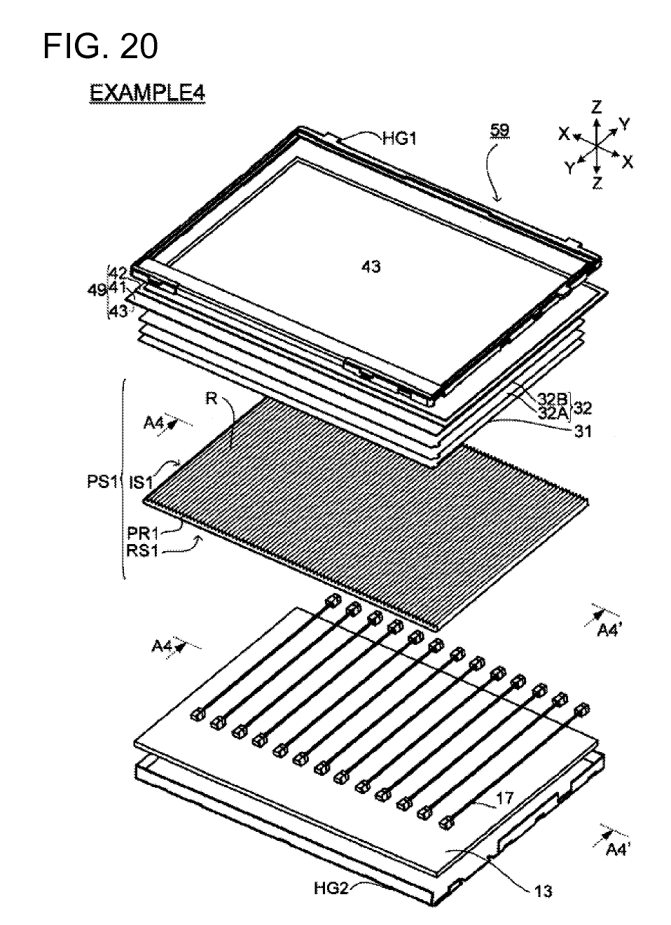

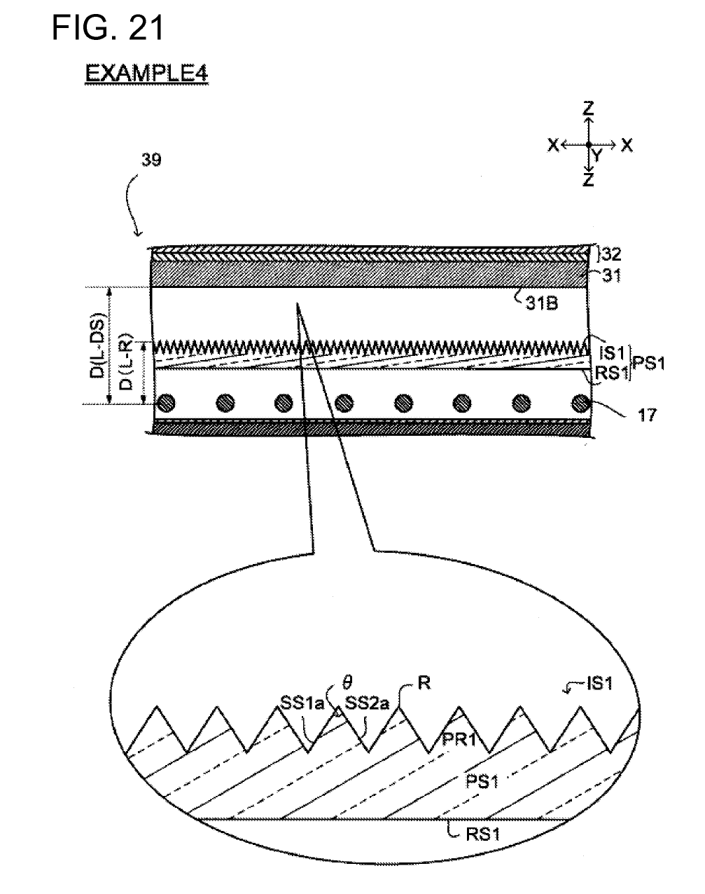

In Embodiments 1 and 2, the LEDs 12 were used as a light source in the backlight unit 39. However, a light source is not limited to the LED 12. For example, as shown in FIGS. 20 and 21 (the cross-sectional arrow view along the line A4-A4′ in FIG. 20), the light source may be fluorescent tubes 17.

In the backlight unit 39 (Example 4) shown in these figures, the fluorescent tubes 17 extend along the Y direction, and are aligned along the X direction. Moreover, unlike Examples 1 to 3, in Example 4, only the first prism sheet PS1 in which the triangle prisms PR1 are aligned in the same direction as the alignment direction of the fluorescent tubes 17 is mounted, and other prism sheets such as the second prism sheet PS2 are not mounted.

This is because the fluorescent tube 17 is a linear light source, and therefore, it is relatively easy light to spread along the linear direction (that is, the Y direction), but it is difficult for light to spread in a direction in which the fluorescent tubes 17 are aligned (that is, the X direction) (particularly, the larger the distance between the fluorescent tubes 17 becomes, the more difficult it becomes for light to spread). Accordingly, in the case of Example 4, as long as a prism sheet PR that is capable of spreading light along the alignment direction of the fluorescent tubes 17 is included, it is unnecessary to include a prism sheet in which the triangle prisms PR extending in the X direction are aligned in the Y direction. Various numeral examples relating to this Example 4 are as follows.

### EXAMPLE 4

The refractive index of the first prism sheet PS1=1.5
The critical angle CA at a boundary surface between the first outgoing face IS1 and air≈42(°)
The shortest distance D(L−R) from the LEDs 12 (the light emitting surface 12L to be precise) to the ridge lines R of the prisms PR1 in the first prism sheet PS1=10 (mm)
The shortest distance D(L−DS) from the radical center of the fluorescent tube 17 to the light-reception face 31B of the diffusion sheet 31=20 (mm)
The thickness of the first prism sheet PS1=2.0 (mm)
The arrangement interval of the triangle prisms PR1 in the first prism sheet PS1=0.1 (mm)
The vertex angle θ of the triangle prism PR1 in the first prism sheet PS1=70(°)
The arrangement interval Px of the fluorescent tubes 17=55 (mm)

In Example 4 described above, similarly to Example 1, the triangle prisms PR1, which refract light coming from the first light-reception face RS1, are formed in the first outgoing face IS1 of the first prism sheet PS1, and one surface of the side surfaces SS1a and SS2a of the triangle prism PR1 refracts light coming from the first light-reception face RS1, and the other side surface SS2a refracts light coming from the one surface. Therefore, Example 4 also has functional effects similar to those of Example 1.

### Other Embodiments

Furthermore, the present invention is not limited to the above-mentioned embodiments, and various modifications are possible without departing from the scope of the present invention.

For example, the prism is not limited to the triangle prism PR having a triangle cross-section. As one example, a prism having other polygonal cross-section (such as a quadrangular or pentagonal cross-section) may be used as well. This is because such a polygonal prism PR includes at least two surfaces, which are a side surface (first refractive face) that refracts light coming from the light-reception face RS, and another side surface (second refractive face) that refracts light coming from the side surface.

Moreover, point-like prisms PR may also be arranged in a matrix instead of aligning the linear-shaped triangle prisms PR. For example, it is also acceptable to use a square pyramidal prism PR, which has a total of four side surfaces including two more side surfaces SS in addition to the two side surfaces SS of the triangle prism PR.

When using a prism sheet PS in which such square pyramidal prisms PR are arranged on the side of the diffusion sheet 31, the two prism sheets PS1 and PS2 are unnecessary unlike Examples 1 to 3. This is because such a prism sheet PS in which the square pyramidal prisms PR are arranged in a matrix can spread light in two directions (the X and Y directions, for example).

Further, the shape of the prism PR is not limited to a square pyramidal shape, and other polygonal pyramidal shapes (or conical shape) may also be used. A trapezoid pyramidal or conical shape instead of a pyramidal or conical shape may also be used for the prism PR. The point is that any prism PR that is capable of spreading light along a direction causing unevenness in light amount such as a dark line may be used.

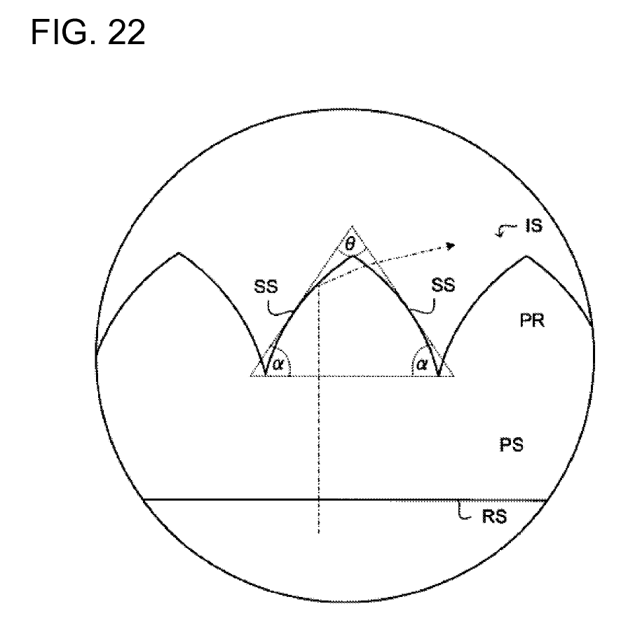

Further, a surface of the prism PR does not have to be flat. For example, as shown in FIG. 22, the surface (side surfaces SS) of the prism PR may be a curved surface that is convex toward the light outgoing side of the prism sheet PS.

When the side surfaces SS are flat such as the triangle prism PR, an outgoing direction from the side surfaces SS is usually almost fixed in accordance with an incident angle to the prism sheet PS. However, when the side surfaces SS are curved surfaces, light transmitting through the curved surfaces travels in many directions. Therefore, when the side surfaces SS of the prism PR are curved surfaces, the occurrence of unevenness in light amount is even more suppressed.

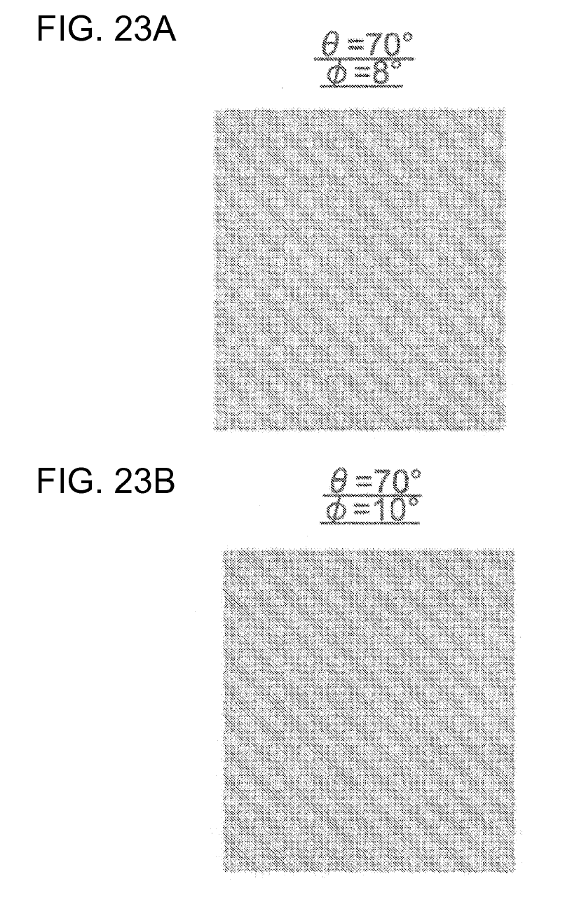

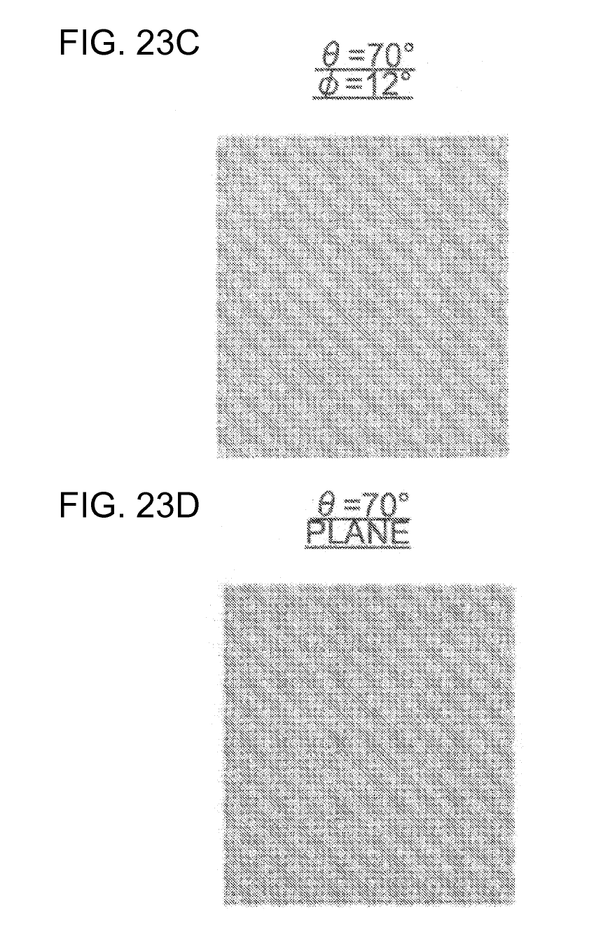

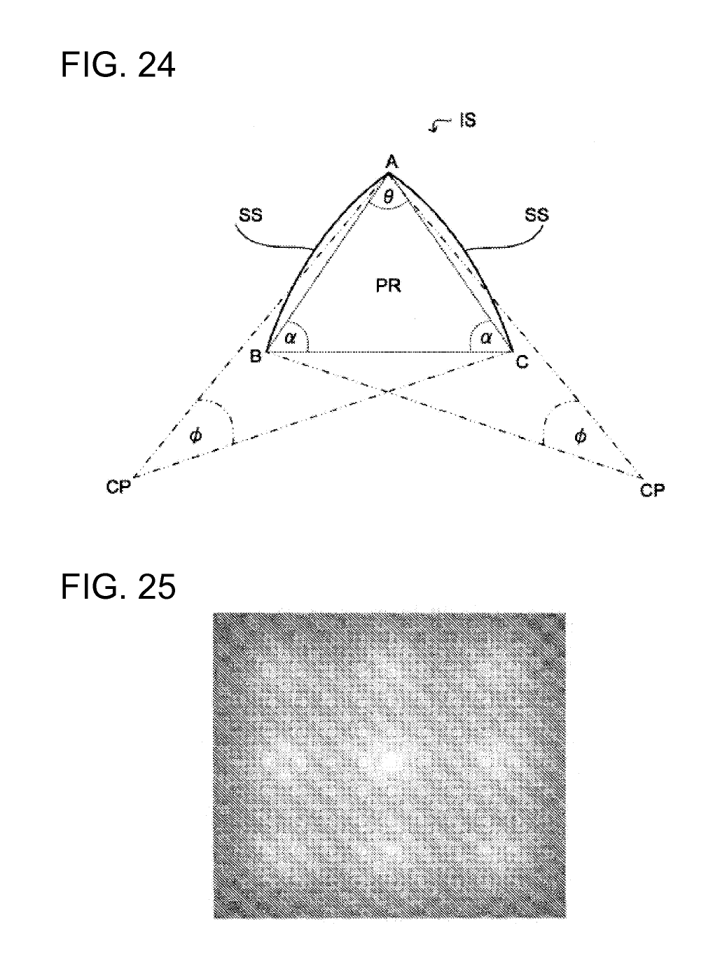

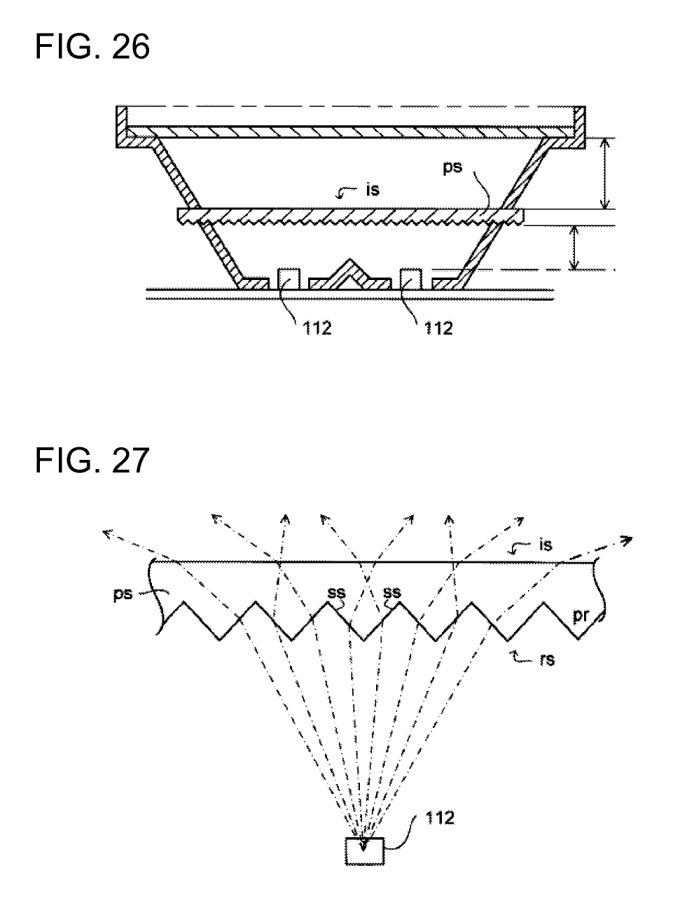

FIGS. 23A to 23D show a difference between the unevenness in light amount caused when the side surfaces of the prism PR are flat, and the unevenness in light amount caused when the side surfaces are curved. These figures are simulation images showing the luminance uniformity on the diffusion sheet 31, and FIGS. 23A to 23C are examples of when the side surfaces SS of the prism PR are curved, and FIG. 23D is an example when the side surfaces SS of the prism PR are flat. From these figures, it is clear that the occurrence of unevenness in light amount is even more suppressed when the side surfaces SS of the prism PR are curved.

Here, as shown in the cross-sectional view in FIG, 24, “φ” in the figures means a central angle φ, which is derived from a circular arc that is a curved line connecting one end A and another end B of curved side surfaces SS (or a circular arc that is a curved line connecting one end A and another end C), and a center of curvature CP located on the side of the light-reception face RS (light-reception side that is opposite to the light outgoing side).

Further, minute recesses and projections for scattering light may also be formed in a part (the side surfaces SS of the prism PR, for example) of the surface of the prism sheet PS. When the surface is in this way, outgoing light from the prism sheet PS is easily spread to various directions. Further, not only on the side surfaces SS of the prism PR, but the minute recesses and projections may also be formed in other areas. The point is that it is acceptable as long as the recesses and projections are formed at least in a part of the surface of the prism sheet PS.

Moreover, if the prism sheet PS includes a light diffusion material, light exiting from the prism sheet PS is likely to spread in various directions. Acrylic resin is one example of a material for the prism sheet PS and the prism, but it is not limited to this.

Moreover, in order to further suppress unevenness in light amount, another diffusion sheet (second diffusion sheet) other than the main diffusion sheet 31 may also be laminated over the prism sheet PS.

The prism sheet PS has been used as an example of a sheet that transmits light from the LEDs 12 or the fluorescent tubes 17 in the description above. However, the present invention is not limited to the prism sheet PS, and the transmission sheet may also be a sheet including hologram (light refractive element) that refracts light, for example.

### DESCRIPTION OF REFERENCE CHARACTERS

PS Prism sheet (transmission sheet)
PS1 First prism sheet (first transmission sheet)
PS2 Second prism sheet (second transmission sheet)
PR Triangle prism (light refractive element, prism)
PR1 Triangle prism formed in the first prism sheet
PR2 Triangle prism formed in the second prism sheet
SS side surface of triangle prism
SS1a One of side surfaces of a triangle prism formed in the first prism sheet (first refractive face/second refractive face)
SS2a The other side surface of the side surfaces of a triangle prism formed in the first prism sheet (second refractive face/first refractive face)
SS1b One of side surfaces of a triangle prism formed in the second prism sheet (first refractive face/second refractive face)
SS2b The other side surface of the side surfaces of a triangle prism formed in the second prism sheet (second refractive face/first refractive face)
R Ridge line of the prism (connecting line)
RS Light-reception face of the prism sheet
RS1 First light-reception face of the first prism sheet
RS2 Second light-reception face of the second prism sheet
IS Outgoing face of the prism sheet
IS1 First outgoing face of the first prism sheet
IS2 Second outgoing face of the second prism sheet
MJ LED module
11 Mounting substrate
11U Mounting surface
12 LED (light source, point light source)
12L Light emitting surface of LED
13 Reflective sheet
31 Diffusion sheet (first diffusion sheet)
32 Optical sheet
D(L−R) Shortest distance from LED to the ridge line of prism in prism sheet (shortest distance from light source to a connecting line between a first refractive face and a second refractive face of light refractive element in transmission sheet)
D(L−DS) Shortest distance from LED to diffusion sheet (shortest distance from light source to the first diffusion sheet)
θ Vertex angle of triangle prism
δ Outgoing angle with respect to prism sheet
CA Critical angle
X Alignment direction (first direction/second direction) of one direction of LEDs that are arranged in a matrix (two dimensional arrangement)
Y Alignment direction (second direction/first direction) of the other direction of LEDs that are arranged in a matrix (two dimensional arrangement)
Z A direction crossing X direction and Y direction
XY LED-mounted surface (two dimensional surface)
P LED arrangement interval
Px Arrangement interval of LEDs along X direction
Py Arrangement interval of LEDs along Y direction
39 Backlight unit (lighting device)
49 Liquid crystal display panel (display panel)
59 Liquid crystal display device (display device)

1. A lighting device, comprising:
a light source; and
a transmission sheet including a light-reception face for receiving light from said light source and an outgoing face for emitting light that has passed through said light-reception face,
wherein said outgoing face includes a light refractive element at least having a first refractive face, which refracts light coming from said light-reception face, and a second refractive face, which refracts light coming from said first refractive face as side surfaces.

2. The lighting device according to claim 1, satisfying a formula below (F1):
$$( 90 ° - \frac{θ}{2} ) + {sin}^{- 1} [ n \cdot sin \{ 180 ° - 3 \cdot ( 90 ° - \frac{θ}{2} ) \} ] > {sin}^{- 1} [ n \cdot sin \{ ( 90 ° - \frac{θ}{2} ) - {sin}^{- 1} ( \frac{sin ( 90 ° - \frac{θ}{2} )}{n} ) \} ] , \qquad ( F1 )$$
where
θ is an angle formed by said first refractive face and said second refractive face, and
n is a refractive index of said transmission sheet.

3. The lighting device according to claim 1,
wherein the refractive index “n” of the transmission sheet is 1.5, and an angle θ formed by said first refractive face and said second refractive face satisfies a formula below (A1):
50°≦θ<88° formula (A1).

4. The lighting device according to claim 2, satisfying a formula below (F2):
$$90 ° > ( 90 ° - \frac{θ}{2} ) + {sin}^{- 1} [ n \cdot sin \{ 180 ° - 3 \cdot ( 90 ° - \frac{θ}{2} ) \} ] > {sin}^{- 1} [ n \cdot sin \{ ( 90 ° - \frac{θ}{2} ) - {sin}^{- 1} ( \frac{sin ( 90 ° - \frac{θ}{2} )}{n} ) \} ] . \qquad ( F2 )$$

5. The lighting device according to claim 4, satisfying a formula below (A2):
50°≦θ<76° formula (A2).

6. The lighting device according to claim 5, satisfying a formula below (A3):
65(°)≦θ<76(°) formula (A3).

7. The lighting device according to claim 1,
wherein a first diffusion sheet for receiving light that has passed through said transmission sheet is included and a formula below (B1) is satisfied:
0.35<D(L−R)/D(L−DS)<1 formula (B1),
where D (L−R) is a shortest distance from said light source to a connecting line of said first refractive face and said second refractive face of a light refractive element in said transmission sheet, and
D(L−DS) is a shortest distance from said light source to said first diffusion sheet.

8. The lighting device according to claim 7, satisfying a formula below (B2):
0.5≦D(L−R)/D(L−DS)≦0.75 formula (B2).

9. The lighting device according to claim 8, satisfying a formula below (B3):
0.5≦D(L−R)/D(L−DS)≦0.625 formula (B3).

10. The lighting device according to claim 1, wherein a connecting line of said first refractive face and said second refractive face is perpendicular to a direction in which said light source is aligned.

11. The lighting device according to claim 10,
wherein said light source is point light sources that are arranged two dimensionally, and when one direction and the other direction that are perpendicular to each other on a two dimensional surface are called a first direction and a second direction, said connecting line becomes perpendicular to one of said first direction and said second direction, which is a direction in which said point light sources are aligned.

12. The lighting device according to claim 11,
wherein there are a plurality of said transmission sheets overlapping with each other, and when said transmission sheet on a side close to said light source is called a first transmission sheet, and said transmission sheet on a side far from said light source is called a second transmission sheet, a connecting line of said first transmission sheet becomes perpendicular to one of said first direction and said second direction, and
wherein a connecting line of said second transmission sheet becomes perpendicular to the other of said first direction and said second direction.

13. The lighting device according to claim 12,
wherein there is a difference between a length of an arrangement interval of said point light sources along said first direction and a length of an arrangement interval of said point light sources along said second direction, and
wherein a direction of a longer arrangement interval becomes perpendicular to the connecting line of said second transmission sheet.

14. The lighting device according to claim 10, wherein said light source is linear light sources that are aligned next to each other.

15. The lighting device according to claim 1, wherein said light refractive element is a prism.

16. The lighting device according to claim 15, wherein said prism is a triangle prism having an isosceles triangle cross-section in which side surfaces are said first refractive face and said second refractive face with an equal length.

17. The lighting device according to claim 1,
wherein said light refractive element is a prism, and
wherein said prism is a point prism including another refractive face as a side surface in addition to said first refractive face and said second refractive face.

18. The lighting device according to claim 1,
wherein a surface of said prism is a curved surface convex toward a light outgoing side of said transmission sheet.

19. The lighting device according to claim 1,
wherein recesses and projections for scattering light are formed in at least a part of a surface of said transmission sheet.

20. The lighting device according to claim 1, wherein said transmission sheet includes a light diffusion material.

21. The lighting device according to claim 1, further comprising a second diffusion sheet for receiving light from said transmission sheet.

22. The lighting device according to claim 1, wherein said light refractive element is a hologram.

23. A display device, comprising:
the lighting device according to claim 1, and
a display panel for receiving light from said backlight unit.
